(19) United States
(12) Patent Application Publication
(10) Pub. No.: US 2025/0073512 A1
(43) Pub. Date: Mar. 6, 2025

(54) FOLDING FRAME TANK FOR ELECTRIC VEHICLE FIRES AND RELATED SYSTEMS AND METHODS

(71) Applicant: FOL-DA-TANK, LLC, Milan, IL (US)

(72) Inventors: Joel Wright, Bettendorf, IA (US); Keith Niebur, Bettendorf, IA (US); Nathan Tindall, Bettendorf, IA (US)

(21) Appl. No.: 18/822,647

(22) Filed: Sep. 3, 2024

Related U.S. Application Data
(60) Provisional application No. 63/580,074, filed on Sep. 1, 2023.

(51) Int. Cl. A62C 3/07; A62C 99/00

(52) U.S. Cl. CPC A62C 3/07; A62C 99/0009

(57) ABSTRACT

A portable, deployable water tank, includes a folding frame having a first and second frame halves each with a first end, a first and second sides each rotatably coupled to the first end such that the first and second sides are each foldable with the first end in an accordion-like fashion. A coupling mechanism is on a second end of each of the first and second sides of each of the first and second frame halves and couples and decouples the first frame half and the second frame half. Each of the first frame half and the second frame half are moveable between a collapsed configuration and a deployed configuration. The tank includes a flexible receptacle having vertical sidewalls and a skirt disposed substantially flat on a surface when the folding frame is in the deployed configuration.

### RELATED APPLICATION(S)

This disclosure claims priority to U.S. Provisional Application Ser. No. 63/580,074, filed Sep. 1, 2023 and entitled “FOLDING FRAME TANK FOR ELECTRIC VEHICLE FIRES AND RELATED SYSTEMS AND METHODS,” the disclosure of which is hereby incorporated by reference in its entirety.

### BACKGROUND

When gas-powered vehicles catch fire, traditional firefighting tactics employ water or foam to extinguish the primary fuel fire (the burning gasoline) and any secondary fire (the burning of tires, interior elements, etc.).

In contrast, an electric vehicle (“EV”) fire poses a unique problem for firefighters, because the batteries are subject to thermal runaway, whereby one burning cell ignites the neighboring cells.

While EV fire tactics employ water or foam to extinguish the secondary fires, firefighting professionals have struggled to develop any effective fire extinguishing solutions that successfully address the risk of thermal runaway in EV batteries. For example, one solution involves fire blankets that are placed over the car in an attempt to limit oxygen to the fire. However, one disadvantage of the use of fire blankets is that it requires the firefighters to get close to the burning vehicle in order to place the blankets. And a further disadvantage is that the blankets must be positioned in a fairly precise manner in order to be effective. Another solution is under-vehicle spray nozzles, which spray water on the underside of the battery compartment to cool the compartment with the goal of stopping thermal runaway. One disadvantage of these nozzles is that they require an uninterrupted water supply to be effective. Finally, the third solution relates to a dumpster that is transported to the fire scene. The dumpster is filled with water and the vehicle is then placed in the dumpster, thereby extinguishing the fire and stopping thermal runaway. But it can take a long time to transport a dumpster to the fire scene and heavy equipment is required to lift the vehicle into the dumpster.

There is a need in the art for improved systems, methods, and devices for extinguishing electric vehicle fires.

### SUMMARY

Disclosed herein are various folding frame tanks for the containment of cooling water around an electric vehicle that is or is close to experiencing thermal runaway. In certain embodiments, the tank includes one or more frames that surround the vehicle and provide walls or dams to contain cooling water within to contact the elements of the electric vehicle experiencing thermal runaway.

In one aspect, there is a portable, deployable water tank, that includes a folding frame having a first and second frame halves each with a first end, a first and second sides each rotatably coupled to the first end such that the first and second sides are each foldable with the first end in an accordion-like fashion. A coupling mechanism is on a second end of each of the first and second sides of each of the first and second frame halves and couples and decouples the first frame half and the second frame half. Each of the first frame half and the second frame half are moveable between a collapsed configuration and a deployed configuration. The tank includes a flexible receptacle having vertical sidewalls and a skirt disposed substantially flat on a surface when the folding frame is in the deployed configuration.

In another aspect, there is a portable, deployable water tank, that includes a folding frame having a first and second frame halves each with a first end, a first and second sides each rotatably coupled to the first end such that the first and second sides are each foldable with the first end in an accordion-like fashion. A coupling mechanism is on a second end of each of the first and second sides of each of the first and second frame halves and couples and decouples the first frame half and the second frame half. Each of the first frame half and the second frame half are moveable between a collapsed configuration and a deployed configuration. The tank includes a flexible receptacle having two halves associated with the first and second frame halves, each of the flexible receptacle halves including vertical sidewalls and a skirt disposed substantially flat on a surface when the folding frame is in the deployed configuration and an attachment structure to connect the first and second flexible receptacle halves.

In yet another aspect, there is a portable, deployable water tank, that includes a folding frame having a frame half with a first end, first and second sides each rotatably coupled to the first end such that the first and second sides are each foldable with the first end in an accordion-like fashion. A coupling mechanism is on a second end of each of the first and second sides of the frame half and couples and decouples the frame half to any additional frame halves. Each of the frame half and the additional frame halves are moveable between a collapsed configuration and a deployed configuration. The tank includes a flexible receptacle having two halves associated with the first and second frame halves, each of the flexible receptacle halves including vertical sidewalls and a skirt disposed substantially flat on a surface when the folding frame is in the deployed configuration and an attachment structure to connect the first and second flexible receptacle halves.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

The following drawings are illustrative of particular examples of the present invention and therefore do not limit the scope of invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1A is an elevated side view of a folding frame tank according to one or more embodiments of the disclosure.

FIG. 1B is an elevated rear view of a folding frame tank according to one or more embodiments of the disclosure.

FIG. 2A is a side view of a side of a folding frame tank according to one or more embodiments of the disclosure.

FIG. 2B is an end view of an end of a folding frame tank according to one or more embodiments of the disclosure.

FIG. 2C is a closeup view of the external side of a connection between two halves of a folding frame tank according to one or more embodiments of the disclosure.

FIG. 2D is a closeup view of the external side of a rotatable connection between two sections of a folding frame tank according to one or more embodiments of the disclosure.

FIG. 3A is another elevated rear view of a folding frame tank according to one or more embodiments of the disclosure.

FIG. 3B is a closeup view of the internal side of a connection between two halves of a folding frame tank according to one or more embodiments of the disclosure.

FIG. 4A is a view of one half of a frame folded in its transportation configuration and contained within a fabric tote according to one or more embodiments of the disclosure.

FIG. 4B is an elevated side view of a folding frame tank before deployment according to one or more embodiments of the disclosure.

FIG. 4C is a view of one half of a frame as it is being deployed according to one or more embodiments of the disclosure.

FIG. 4D is another of a half of a frame as it is being deployed according to one or more embodiments of the disclosure.

FIG. 4E is another view of two halves of a frame as they is being deployed according to one or more embodiments of the disclosure.

FIG. 4F is another elevated side view of a folding frame tank according to one or more embodiments of the disclosure.

FIG. 4G is an interior view of a skirt with floor weights of a folding frame tank according to one or more embodiments of the disclosure.

FIG. 4H is a view showing floor weights in a folded transportation configuration according to one or more embodiments of the disclosure.

FIG. 5 is a flow chart showing the process of using a folding frame tank according to one or more embodiments of the disclosure.

FIG. 6A is an elevated side view of a folding frame tank according to one or more embodiments of the disclosure.

FIG. 6B is an elevated rear view of a folding frame tank according to one or more embodiments of the disclosure.

FIG. 7A is an end view of an end of a folding frame tank according to one or more embodiments of the disclosure.

FIG. 7B is a closeup view of the external side of a connection between two halves of a folding frame tank according to one or more embodiments of the disclosure.

FIG. 7C is another closeup view of the external side of a connection between two halves including a coupler of a folding frame tank according to one or more embodiments of the disclosure.

FIG. 7D is a closeup view of the internal side of a connection between two halves of a folding frame tank according to one or more embodiments of the disclosure.

FIG. 8A is a view of a frame folded in its transportation configuration according to one or more embodiments of the disclosure.

FIG. 8B is a closeup view of the external side of a rotatable connection between two sections of a folding frame tank according to one or more embodiments of the disclosure.

FIG. 9A is an elevated side view of a folding frame tank according to one or more embodiments of the disclosure.

FIG. 9B is a closeup view of one section of a folding frame tank according to one or more embodiments of the disclosure.

FIG. 9C is another closeup view of one section of a folding frame tank according to one or more embodiments of the disclosure.

FIG. 10A is an end view of an end of a folding frame tank before connecting the end sections according to one or more embodiments of the disclosure.

FIG. 10B is another end view of an end of a folding frame tank before connecting the end sections according to one or more embodiments of the disclosure.

FIG. 10C is another view of a folding frame tank during deployment according to one or more embodiments of the disclosure.

FIG. 10D is another view of a folding frame tank during deployment according to one or more embodiments of the disclosure.

FIG. 10E is another view of a frame folded in its transportation configuration according to one or more embodiments of the disclosure.

FIG. 10F is another view of a frame folded in its transportation configuration according to one or more embodiments of the disclosure.

FIG. 11A is a view of a frame folded in its transportation configuration and placed behind a target vehicle according to one or more embodiments of the disclosure.

FIG. 11B another view of a frame folded in its transportation configuration and placed behind a target vehicle according to one or more embodiments of the disclosure.

FIG. 11C is a view of a frame as it is deployed around a target vehicle according to one or more embodiments of the disclosure.

FIG. 11D is another view of a frame as it is deployed around a target vehicle according to one or more embodiments of the disclosure.

FIG. 11E is another view of a frame as it is deployed around a target vehicle according to one or more embodiments of the disclosure.

FIG. 11F is another view of a frame as it is deployed around a target vehicle according to one or more embodiments of the disclosure.

FIG. 11G is another view of a frame as it is deployed around a target vehicle according to one or more embodiments of the disclosure.

FIG. 11H is another view of a frame as it is deployed around a target vehicle according to one or more embodiments of the disclosure.

FIG. 12A is a view of a side of a frame showing support structures deployed around the frame according to one or more embodiments of the disclosure.

FIG. 12B is an interior view of a skirt with floor weights of a folding frame tank according to one or

more embodiments of the disclosure.

FIG. 13A is a view of a deployed folding frame tank around a target vehicle with an emergency vehicle to fill the tank with water according to one or more embodiments of the disclosure.

FIG. 13B is a view of a filled and deployed folding frame tank according to one or more embodiments of the disclosure.

FIG. 14A is a closeup view of a support structure of a deployed folding frame tank according to one or more embodiments of the disclosure.

FIG. 14B is another closeup view support structure of a deployed folding frame tank according to one or more embodiments of the disclosure.

FIG. 14C is another closeup view support structure of a deployed folding frame tank according to one or more embodiments of the disclosure.

FIG. 14D is another closeup view support structure of a deployed folding frame tank according to one or more embodiments of the disclosure.

FIG. 14E is another closeup view support structure of a deployed folding frame tank according to one or more embodiments of the disclosure.

### DETAILED DESCRIPTION

The various embodiments herein relate to a portable, collapsible water tank that can be quickly deployed around a burning electric vehicle (without having to move the vehicle), filled with water to extinguish the EV fire, and then easily folded or collapsed back into a collapsed configuration for easy transport after the fire has been extinguished and storage. The various implementations disclosed or contemplated herein can effectively stop or prevent thermal runaway at the scene of the fire, thereby allowing the vehicle to be safely transported away from the scene once the fire has been extinguished. According to certain embodiments, any of the various deployable tank embodiments as disclosed or contemplated herein can be deployed around the electric vehicle after any secondary fire has been extinguished such that the tank can be filled with water to extinguish the battery fire and any thermal runaway that may be occurring.

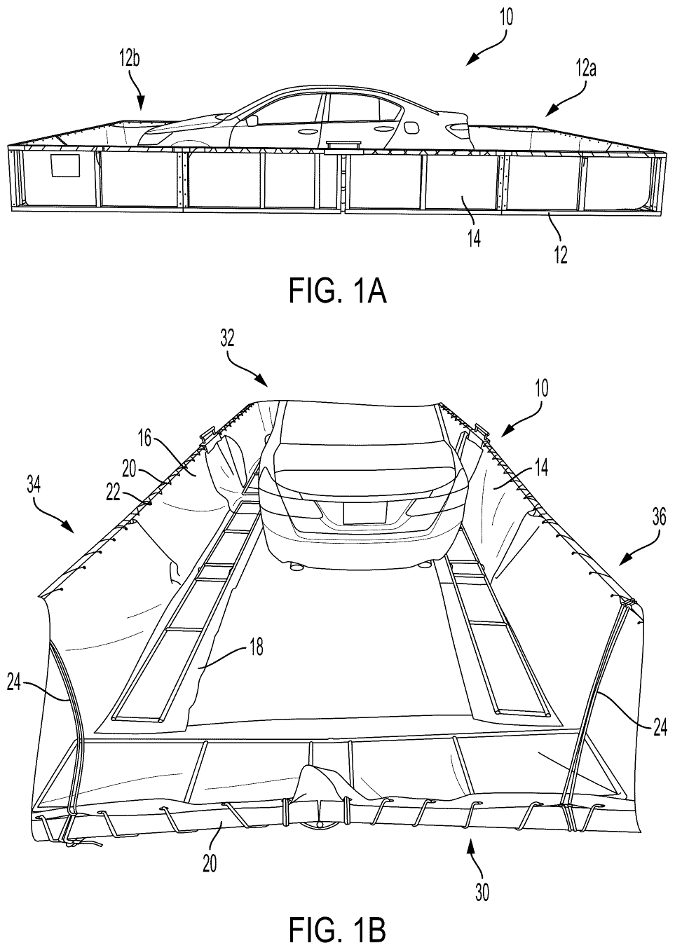

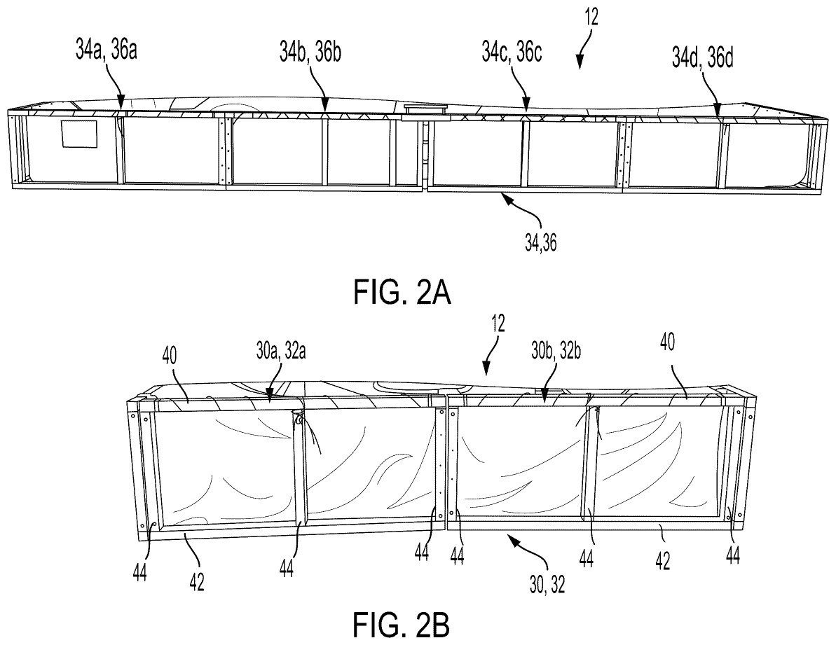

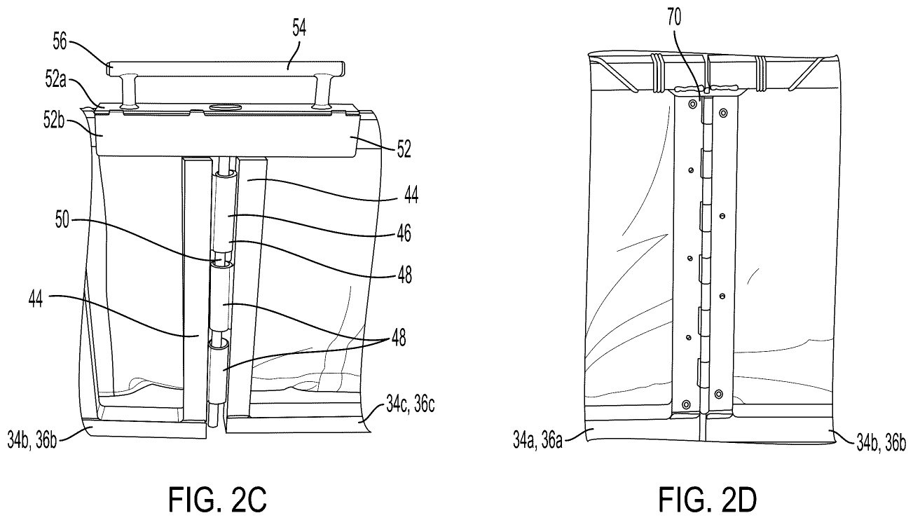

As shown in FIGS. 1A and 1B according to one embodiment, a portable, deployable water tank 10 has a folding frame 12 and a flexible receptacle 14 made from conventional foldable water-tight material. The receptacle 14 has vertical sidewalls 16 secured to the frame 12 and a horizontal skirt or flange 18 that extends from the vertical sidewalls 16 as best shown in FIG. 1B and as discussed in further detail below. According to one embodiment, the vertical sidewalls 16 can be secured to the frame 12 with a rope 20 or similar material threaded through openings 22 along the upper edge portion of the receptacle 14 and spirally wound around the upper rails (reference numeral 40 as seen in FIG. 2B) of the frame 12 as shown. Alternatively, the receptacle 14 can be attached to the frame 12 via any known mechanism, component, or method. The frame 12 forms a free-standing structure to provide support to the sidewalls 16 in the vertical position so as to keep the receptacle 14 in the deployed position as shown in FIGS. 1A-B around the target vehicle such that the tank 10 can receive water to extinguish the fire in the vehicle.

The frame 12 as shown in FIGS. 2A-B, according to one embodiment, has four sides, with two shorter opposing sides (or ends) 30, 32 and two elongate opposing sides 34, 36, according to one embodiment. Each of the sides 30, 32, 34, 36 is made up of at least two frame sections. More specifically, in the exemplary embodiment shown in FIGS. 2A-2B the first end 30 and the second end 32 are each made up of two sections 30a and 30b and 32a and 32b, respectively. The sections 30a and 30b and 32a and 32b are each rotatably coupleable to one another at one end and further are rotatably coupled to each of the elongate sides 32, 34 at the other end. In the specific exemplary embodiment shown, each section of the frame 12 is made up of a top rail 40, a bottom rail 42, and three vertical rails 44 disposed between and connecting the top rail 40 and bottom rail 42 defining a substantially rectangular section having opposite connectable ends, although it should be known that each section may include more or fewer rails in differing configurations (e.g., with a single center rail extending from one corner to an opposite corner) and each section may differ based on location within the frame 12.

In the specific exemplary embodiment shown, the frame 12 comprises 12 sections. Section 34a is rotatably coupled to end section 32b with an internal rotatable joint (e.g., a piano hinge) on one end, and rotatably coupled to side section 34b with an external rotatable joint (e.g., a piano hinge) on another end. Section 34b is rotatably coupled to side section 34a with an external rotatable joint (e.g., a piano hinge) on one end, and is removably coupled to side section 34c via a coupler as described in detail below on the other end. Section 34c is removably coupled to side section 34b via a coupler as described in detail below at one end and is rotatably coupled to side section 34d with an external rotatable joint (e.g., a piano hinge) on another end. Section 34d is rotatably coupled to end section 31a with an internal rotatable joint (e.g., a piano hinge) on one end, and rotatably coupled to side section 34c with an external rotatable joint (e.g., a piano hinge) on another end. Section 31a is rotatably coupled to side section 34d with an internal rotatable joint (e.g., a piano hinge) on one end, and rotatably coupled to end section 31b with an external rotatable joint (e.g., a piano hinge) on another end. Section 31b is rotatably coupled to side section 36a with an internal rotatable joint (e.g., a piano hinge) on one end, and rotatably coupled to end section 31a with an external rotatable joint (e.g., a piano hinge) on another end.

Similarly to the above, Section 36a is rotatably coupled to end section 31b with an internal rotatable joint (e.g., a piano hinge) on one end, and rotatably coupled to side section 36b with an external rotatable joint (e.g., a piano hinge) on another end. Section 36b is rotatably coupled to side section 36a with an external rotatable joint (e.g., a piano hinge) on one end, and is removably coupled to side section 36c via a coupler as described in detail below on the other end. Section 36c is removably coupled to side section 36b via a coupler as described in detail below at one end and is rotatably coupled to side section 36d with an external rotatable joint (e.g., a piano hinge) on another end. Section 36d is rotatably coupled to end section 32a with an internal rotatable joint (e.g., a piano hinge) on one end, and rotatably coupled to side section 36c with an external rotatable joint (e.g., a piano hinge) on another end. Section 32a is rotatably coupled to side section 36d with an internal rotatable joint (e.g., a piano hinge) on one end, and rotatably coupled to end section 32b with an external rotatable joint (e.g., a piano hinge) on another end. Section 32b is rotatably coupled to side section 34a with an internal rotatable joint (e.g., a piano hinge) on one end, and rotatably coupled to end section 32a with an external rotatable joint (e.g., a piano hinge) on another end.

As described above, the side sections have external rotatable joints (i.e., the hinge or other joint is on the outside of the perimeter of the frame 12) such that pressure exerted outwardly from an amount of water held within the tank 10 forces mating rails of adjacent sections together, increasing the resistive strength of the overall frame 12 by removing the stresses from the joint (e.g., the hinge itself) and placing it on the rails. Conversely, the end sections mate with corresponding side sections via internal joints (i.e., the hinge or joint is on the inside of the perimeter of the frame 12) to allow for a 90 degree internal bend in the perimeter of the frame 12. The oppositely folding joints also allow for the frame halves 12a, 12b to be folded upon themselves for easy and convenient storage and deployment. While the sections and their respective configurations have been described in detail above, it should be known that other configurations and numbers of the sections of the frame 12 may be assembled without deviating from the scope of the disclosure.

The two elongate sides 34, 36 are made up of four sections 34a-d, 36a-d as best shown in FIG. 2A. Two pairs of each of the four sections are rotatably coupled to an adjacent section (e.g., 34a is rotatably coupled to 34b, 34c is rotatably coupled to 34d, 36a is rotatably coupled to 36b, and 36c is rotatably coupled to 36d), Each of the end sections of the sides 34, 36 is also rotatably coupled to one of the sections of one of the ends 30, 32 (e.g., 34a is rotatably coupled to 32b, 34d is rotatably coupled to 30a, 36a is rotatably coupled to 30b, and 36d is rotatably coupled to 32a). Alternatively, each of the four sides 30, 32, 34, 36 can be made up of any number of sections as needed to ensure that the frame 12 is sized to fit about any potential vehicle for purposes of extinguishing a fire in that vehicle.

The frame 12 in some embodiments, may comprise two halves 12a, 12b (as shown in FIG. 1A) of the total frame 12. As shown in FIGS. 2C, in the embodiment shown, the two halves 12a, 12b are connected at the midpoints of the elongated sides 34, 36 (e.g., at the connection of sections 34b to 34c, and 36b and 36c) by a coupling mechanism 46, described in detail below.

Each of the middle sections 34b-c, 36b-c may include a portion of a coupling mechanism 46 which in the embodiment shown includes three tubes 48, two of the tubes 48 on one middle section and one on the other. It should be known that different numbers of tubes may be utilized and in different configurations without deviating from the scope of the disclosure. In this specific exemplary embodiment, the coupling mechanism is two tubes 48 attached to an end of sections 34b and 36b that are aligned with a single tube 48 attached to a mating end of sections 34c and 36c, thereby allowing a rod or the like to be inserted through the tubes 48 such that the frame sections 34b and 34c, and 36b and 36c are coupled together. Alternatively, the coupling mechanism 46 can be any known device, mechanism, or feature that can be used to couple sections 34b to 34c and 36b to 36c.

When the tubes 48 of the coupling mechanism 46 are brought together, they can form a single cylinder within which a portion or an element of a coupler 56 may be placed to hold the sections (i.e., 34b to 34c and 36b to 36c) together. The coupler 56 of an embodiment includes a pin 50 that slides downward through the tubes 48, holding the respective sections together, while a top portion 52a of a coupling bracket 52 rests upon the top of the frame 12 on top rail 40 of the adjacent sections being coupled and provides resistance to rotation between the sections (i.e., between the sections 32b and 32c, and between 36b and 36c). Rotation is resisted by downstanding flanges 52b that are located along the length of the top portion 52a of the coupling bracket 52. While one downstanding flange 52b is shown, it should be known that a second downstanding flange 52b is located on the opposite side of the top portion 52a. The downstanding flanges 52a capture the top rail 40 of each of sections 34b, 34c, 36b, and 36c, respectively, and prevent their rotation relative to one another.

As shown in FIG. 2D, each of the other sections may be connected through rotatable joints 70. In the embodiment shown, the rotatable joint 70 may be a piano hinge. It should be known that any other type of rotatable joint mechanism may be used to provide rotation of and strength to the joint 70.

The frame 12, in some implementations, can be made of aluminum tubing or other metal tubing. In the embodiment shown, the frame 12 comprises a number of 2-inch square aluminum tubes welded together to form the sections as shown. Alternatively, in other embodiments, the frame 12 can be made of any metal or other rigid material that can be incorporated into the frame 12 to allow the frame 12 to function as described herein.

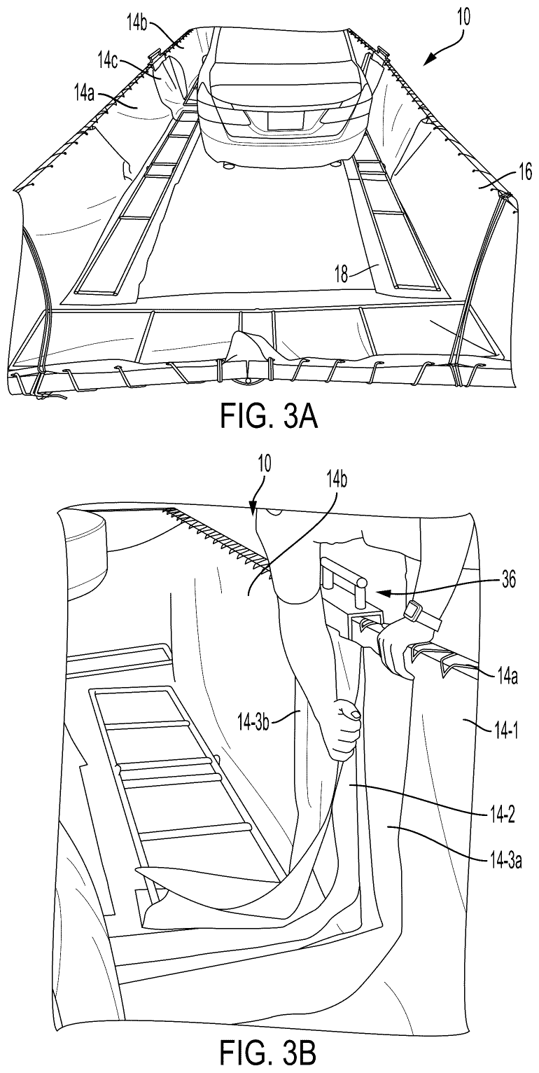

Looking now at FIGS. 3A-3B, in accordance with certain embodiments, the flexible receptacle 14 is comprised of two halves 14a and 14b that correspond to frame halves 12a and 12b. The two halves 14a, 14b of the flexible receptacle 14 meet at a pair of connections 14c on either side of the vehicle. As shown, the connections 14c are at or near the midpoint of the elongated sides 34, 36, but it should be known that the connection points may be located at any convenient location for strength and ease of assembly, tear down, and transportation. The flexible receptacle 14 may attach to a top of the frame 12 via rope or cord 20 that is fed through holes 22 in the flexible receptacle 14. The rope or cord may be heavy duty 4 mm nylon accessory cord or any other rope or cord that can stably provide connection between the flexible receptacle 14 and the frame 12. Excessive outward bending in the corners may be prevented by corner straps or cords 24 that are attached between end sections and side sections so as to not allow external over-bending of the corner hinges. The corner cords may be heavy duty 4 mm nylon accessory cord or any other cord or structure that provides the strength necessary for over-bending prevention.

As shown in FIG. 3B, the connection points 14c of the flexible receptacle 14 in the embodiment shown comprise three layers of material 14-1, 14-2, and 14-3. The base flexible receptacle material 14-1 provides a base connection whereby the base material 14-1 of each of halves 14a and 14b are attached to one another by any means known in the art (as shown they are connected via a hook and loop connection, but it should be known that any type of connection such as a zipper is within the scope of the disclosure). The second layer is a thin strip of material 14-2 that is attached over the top of the connection of the base material 14-1 of sections 14a and 14b. This strip 14-2 may be sewn on one side and hook and loop connected on the other, sewn on one side and zipper on the other, hook and loop on both sides, welded on one side and hook and loop or zipper on the other, or any combination thereof. The strip 14-2 provides a second layer of protection against water extrusion from the tank 10. The final layer in the embodiment shown in FIG. 3B is an overlay 14-3. The overlay 14-3 in the embodiment shown is comprised of a pair of flexible flanges 14-3a and 14-3b having sides that are permanently affixed to the sections 14a, 14b, and second sides that provide for selective attachment to one another over the top of the strip 14-2. The permanent attachments may be via sewing or welding, and the selective attachment may be via hook and loop, zipper, or any other selective attachment and detachment mechanism. While the connection 14c has been shown in three layers of different attachments and locations, it should be known that any combination of the described layers may be utilized without deviating from the scope of the disclosure.

In the embodiment shown, the skirt 18 is attached to or an integral portion of the vertical sidewalls 16 such that the skirt 18 extends horizontally from the bottom of the sidewalls 16 inward toward the center of the deployed tank 10 as shown around the entire circumference thereof. The skirt 18 has a width ranging from about 1 foot to about 3 feet. Alternatively, the skirt 18 has a width of about 18 inches. In a further alternative, the skirt 18 can be any width that allows for the skirt 18 to be deployed in contact with the surface on which the tank 10 is deployed such that it helps to retain water within the tank 10 as described elsewhere herein. In use, as will be described in additional detail below, the skirt 18 functions to retain water within the tank 10.

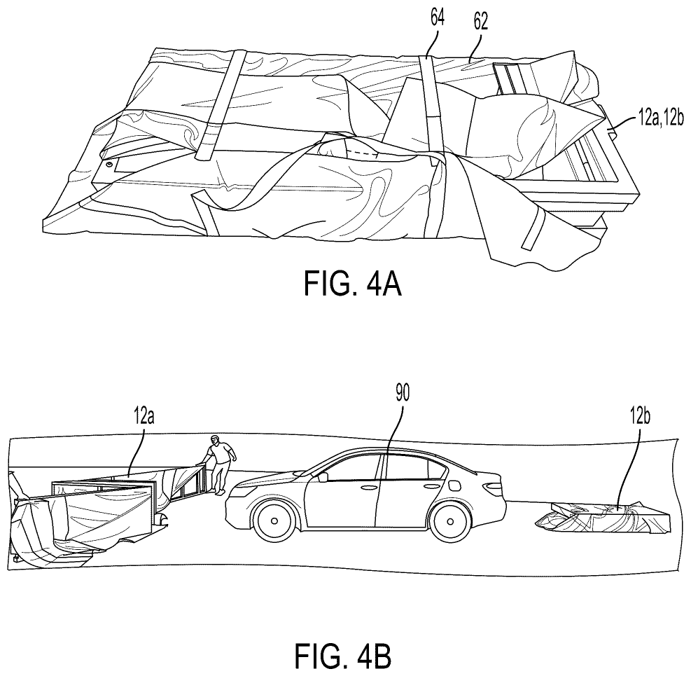

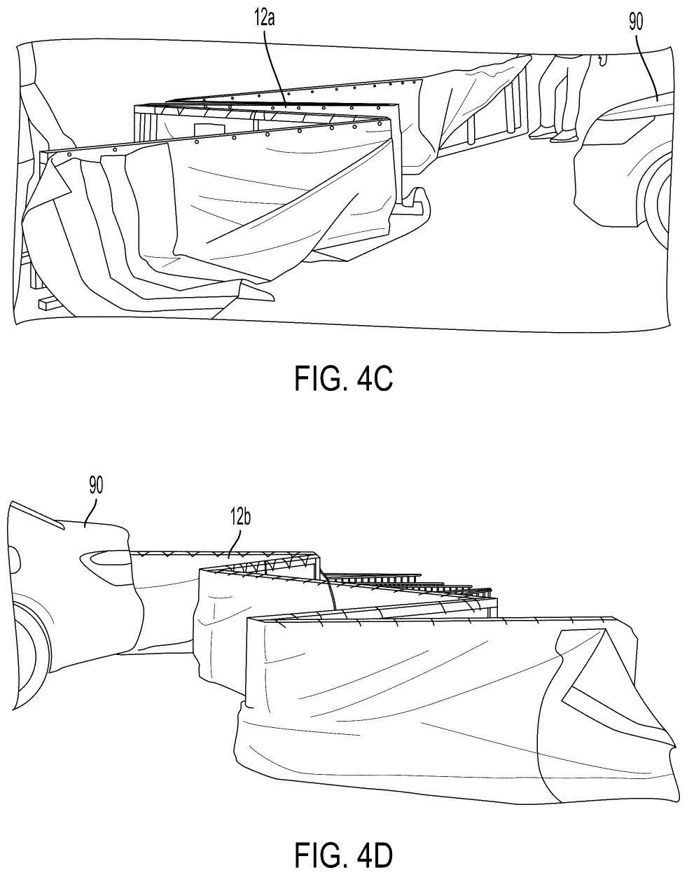

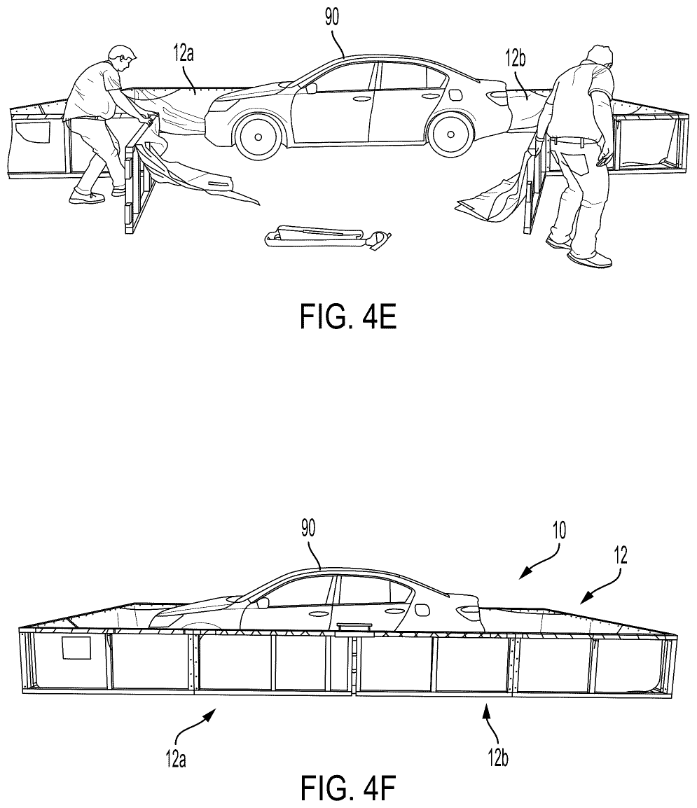

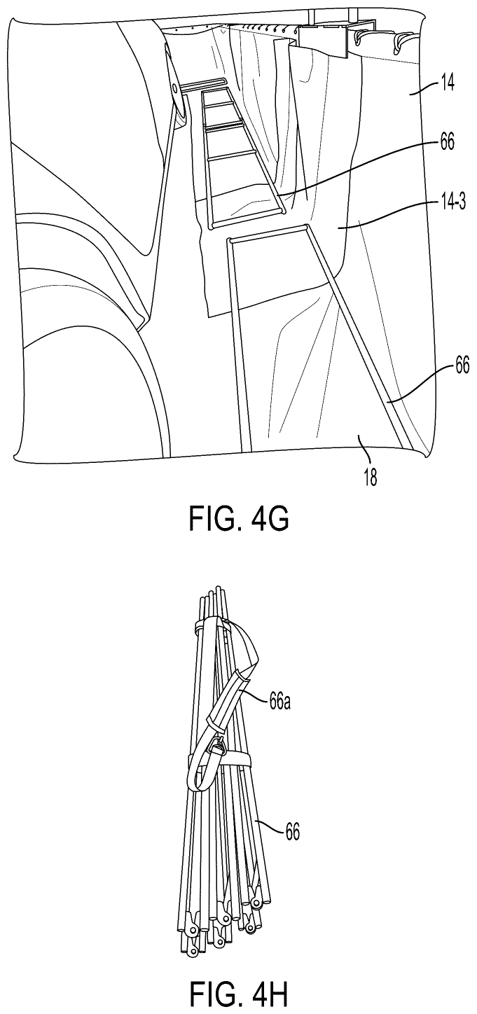

FIGS. 4A-4H depict how the entire tank 10 can be deployed around a vehicle 90 by placing the two halves 12a, 12b of the frame on either end of the vehicle 90. Each half may be contained within a fabric sling 62 with heavy duty webbing handles 64 to provide for quick and easy transportation. The frame halves 12a, 12b are then unfolded such that each extends outwardly and then is pulled forward (e.g., section 12b) or rearward (e.g., section 12a) to wrap around an extended perimeter (i.e., a perimeter defined around and at a distance from the vehicle 90) around the vehicle 90 and meet near the middle of the vehicle 90 at the connection 14c (see FIG. 3A). The flexible receptacle 14 may already be pre-attached to the frame 12, attached as the frame 12 is unfolded, or may be attached upon connection of the sections 12a, 12b.

When the sections 12a and 12b are unfolded, they may be operably connected by the coupler 56. On each side of the tank 10, the tubes 48 of the coupling mechanism 46 are lined up, and the pin 50 of the coupler 56 is slid downwardly through the tubes 48, operably closing the frame sections 12a, 12b and creating a unitary frame 12 around the perimeter of the vehicle 90. The skirt 18 is then located such that it is flat on the ground within the frame 12, and floor weights 66 (described in detail below) are unfolded from their straps 66a and placed on the skirt 18 to ensure good contact with the surface.

As shown in FIG. 4G, in certain optional embodiments, a skirt anchor (or “floor weight,” or simply “weight”) 66 is provided for use with the tank 10. More specifically, after deployment of the tank 10, the skirt anchor 66 can be disposed on any portion of the skirt 18 to hold the skirt 18 down/against the surface that the tank 10 and is positioned on to ensure that the water being added to the tank 10 substantially remains therein and doesn't begin flowing out of the tank 10 underneath the skirt 18. According to one embodiment, the skirt anchor 66 as shown has a length that allows it to be positioned on either of the skirts 18 disposed along the length of one of the elongate sides 34, 36. Alternatively, the skirt anchor 66 (or a second such anchor) can have a length that allows it to be positioned on either of the skirts 18 disposed along the length of the ends 30, 32. In further implementations, two, four, six, eight, or any other number of skirt anchors 66 of appropriate lengths are provided.

According to certain embodiments, when the deployed tank 10 begins to be filled with water, turbulence and/or the force of the water being introduced into the tank 10 can cause any portion of the skirt 18 to lift away from the surface on which the tank 10 is positioned, thereby allowing the water to flow out of the tank 10 underneath the skirt 18. When this happens, one or more skirt anchors 66 as discussed above can be positioned over that portion of the skirt 18, thereby maintaining the position of skirt 18 against the surface and minimizing the amount water flowing out. Once a sufficient amount of water has been added to the tank 10, the weight of the water on the skirt 18 provides sufficient force to prevent any portion of the skirt 18 from lifting away from the surface, and the anchor 66 can be optionally removed.

In use, once the tank 10 is deployed the tank 10 can be filled with water. In certain embodiments, any water source and/or appropriate transport device can be used to fill the tank 10 (e.g., a firetruck as described in detail in another embodiment below). After the tank 10 is filled with water, the fire or thermal runaway in the vehicle is extinguished. The water may then be drained. Once the water has been drained from the tank 10, the tank 10 can then be returned to its collapsed configuration by removing the floor weights 66 and folding and stowing with the straps 66a (e.g., securing the floor weights in their folded position using the straps 66a having hook and loop or any other type of securing device for easy transportation), optionally removing the flexible receptacle, removing the couplers 56 from the sections of the frame 12, and folding the sections 12a, 12b back into their respective fabric slings 62.

During use, it should be noted that some minimal amount of water may escape from the tank 10 via the connections 14c and underneath the skirt 18. However, surprisingly, the amount of water that escapes is a minimal amount such that the tank 10 retains a sufficient amount of water for a sufficient amount of time to ensure that the fire or thermal runaway in the vehicle disposed within the tank is extinguished. Testing has shown that the skirt 18 makes it possible to retain sufficient amounts of water across a wide variety of surfaces, including smooth pavement, gravel, and other such surfaces.

While the exemplary embodiment shown includes two frame halves that are joined together near a midpoint of a vehicle, it should be known that three, four, or any number more frame halves may be joined together to create a larger tank 10 for larger vehicles or other items that may need a similar tank erected quickly and efficiently.

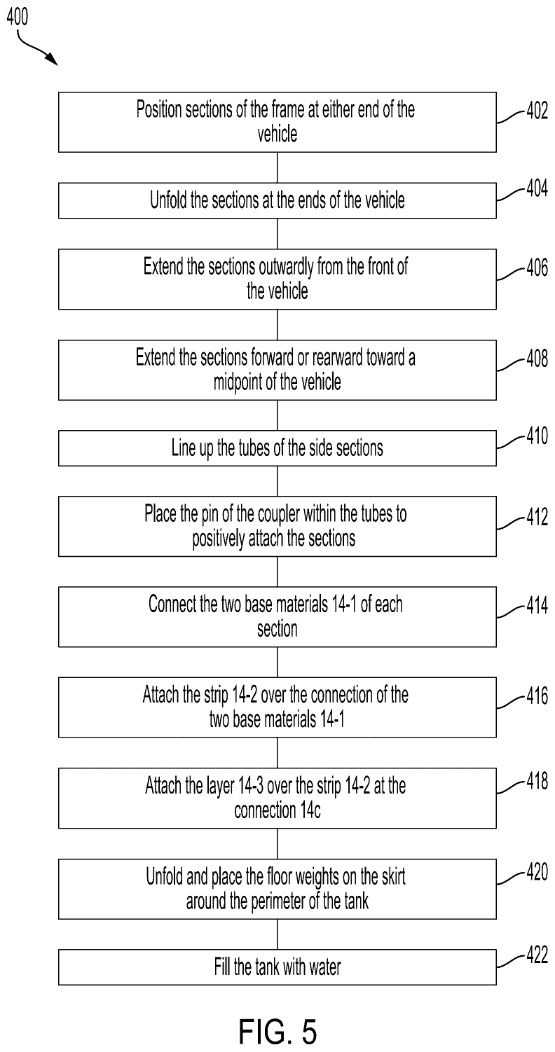

FIG. 5 shows an exemplary process 400 for using the foldable tank according to one or more of the described embodiments. The process 400 may use all of the elements of the foldable tank 10 of the embodiments of FIGS. 1-4, or certain elements may be omitted or added to the foldable tank without deviating from the scope of the disclosure. In the exemplary process 400, once a vehicle is identified as potentially succumbing to thermal runaway, in step 402 the frame halves 12a, 12b are positioned at either end of the vehicle. In some embodiments, more halves may be used to expand the perimeter of the frame (although still called “halves” within the disclosure, it is understood that more than two of the halves may comprise the whole frame). Once the halves are in position, in step 404 the sections are unfolded. To begin positioning the halves around the vehicle, in step 406 the side portions are extended outwardly to the sides of the vehicle, while the ends are located in their position. In step 408, the sides are then extended forward or rearward toward one another near the midpoint of the vehicle.

Once the sides are substantially in their deployed positions, the tubes of the coupling mechanisms are aligned, forming a single cylinder in step 410. In step 412, the pin of the coupler is placed into the single cylinder formed by the different coupling mechanisms of the sections.

Once the pin is set in place, effectively coupling the entire frame into a singular unit (e.g., the frame 12 of one embodiment), the base material of the different halves of the flexible receptacle are connected in step 414. In some embodiments, this connection is a hook and loop connection, while in other embodiments this could be any other connection such as a zipper or the like. In step 416, the secondary layer (e.g., a strip of a similar material to the base material) is attached over the base material connection to offer a more watertight connection. The secondary layer may attach removably from one (e.g., may be sewn or welded to one side, and removably attach to the other) or both of the flexible receptacle halves via similar connection methods. The secondary layer may be attached (permanently or otherwise) on either side of the base material connection to fully cover the base layer connection. In step 418, a tertiary layer is overlaid over both the main layer and secondary layer connections to provide a final water seal between the tank and the surface upon which the tank is resting. The tertiary layer may attach removably from one (e.g., may be sewn or welded to one side, and removably attach to the other) or both of the flexible receptacle halves via similar connection methods. The tertiary layer may be attached (permanently or otherwise) on either side of the base material connection and the secondary layer or strip to fully cover both the base layer connection and the secondary strip.

With the frame halves and the flexible receptacle halves connected and in place, the floor weights may be placed on the skirt of the flexible receptacle to aid in solid contact between the skirt and the underlying surface in step 420. Finally, the tank is filled with water in step 422 to cool the vehicle that may be undergoing thermal runaway, thus preventing further damage to the vehicle and its surroundings.

In another embodiment, a foldable tank functions in a similar fashion as described above with the following differences as described below. Some of the elements of the following embodiments may be used in place of similar elements in other embodiments without deviating from the scope of the disclosure. Similar reference numerals may indicate similar elements between the exemplary embodiments.

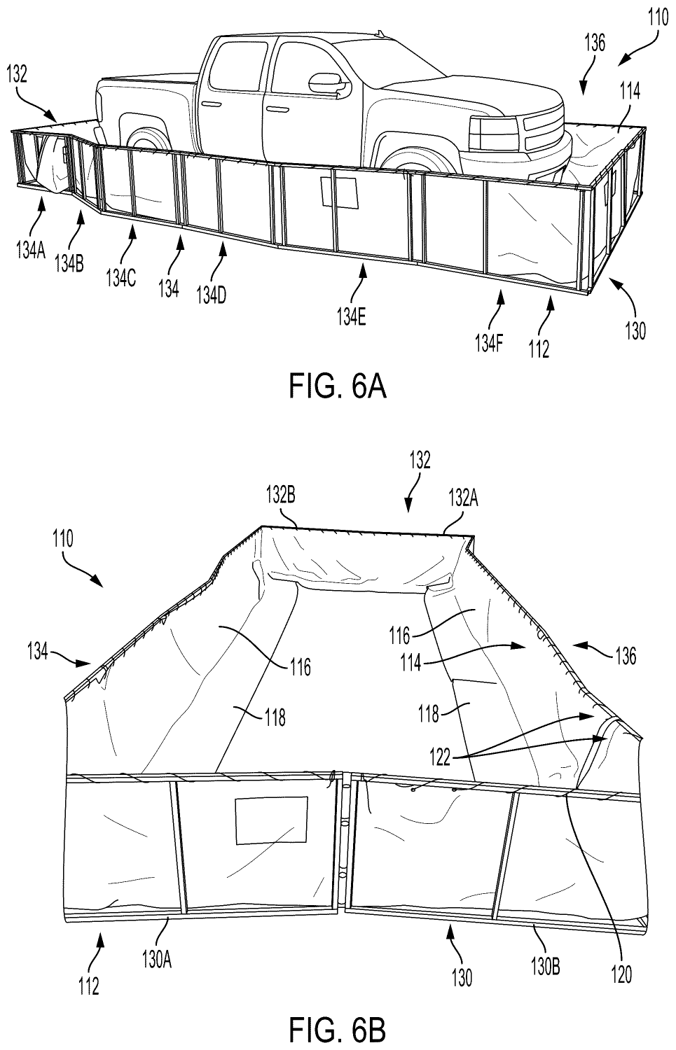

As shown in FIGS. 6A and 6B according to one embodiment, a portable, deployable water tank 110 has a folding frame 112 and a flexible receptacle 114 made from conventional foldable water-tight material. The receptacle 114 has vertical sidewalls 116 secured to the frame 112 and a horizontal skirt or flange 118 that is extends from the vertical sidewalls 116 as best shown in FIG. 6B and as discussed in further detail below. According to one embodiment, the vertical sidewalls 116 can be secured to the frame 112 with a rope 120 or similar material threaded through openings 122 along the upper edge portion of the receptacle 114 and spirally wound around the upper rails of the frame 112 as shown. Alternatively, the receptacle 114 can be attached to the frame 112 via any known mechanism, component, or method. The frame 112 forms a free-standing structure to provide support to the sidewalls 116 in the vertical position so as to keep the receptacle 114 in the deployed position as shown in FIGS. 6A-B around the target vehicle such that the tank 110 can receive water to extinguish the fire in the vehicle.

The frame 112 as shown in FIGS. 6A-B, according to one embodiment, has four sides, with two shorter opposing sides (or ends) 130, 132 and two elongate opposing sides 134, 136, according to one embodiment. Each of the sides 130, 132, 134, 136 is made up of at least two frame sections. More specifically, the first end 130 is made up of two sections 130A, 130B that are each removably coupleable to the other at one end and further are rotatably coupled to one of the elongate sides 134 at the other end. Further, the second end 132 is made up of two sections 132A, 132B that are each rotatably coupled to the other at one end, and further are rotatably coupled to one of the elongate sides 134 at the other end. Finally, the two elongate sides 134, 136 are made up of six sections (such as sections 134A-134F as best shown in FIG. 6A) that are rotatably coupled to each other, while each of the end sections of the sides 134, 136 is also rotatably coupled to one of the sections of one of the ends 130, 132. Alternatively, each of the four sides 130, 132, 134, 136 can be made up of any number of sections as needed to ensure that the frame 112 is sized to fit about any potential vehicle for purposes of extinguishing a fire in that vehicle.

The frame 112, in some implementations, can be made of aluminum tubing or other metal tubing. Alternatively, the frame 112 can be made of any metal or other rigid material that can be incorporated into the frame 112 to allow the frame 112 to function as described herein.

In accordance with certain embodiments, the skirt 118 is attached to or an integral portion of the vertical sidewalls 116 such that the skirt 118 extends horizontally from the bottom of the sidewalls 116 inward toward the center of the deployed tank 110 as shown around the entire circumference thereof. The skirt 118 has a width ranging from about 1 foot to about 3 feet. Alternatively, the skirt 118 has a width of about 18 inches. In a further alternative, the skirt 118 can be any width that allows for the skirt 118 to be deployed in contact with the surface on which the tank 110 is deployed such that it helps to retain water within the tank 110 as described elsewhere herein. In use, as will be described in additional detail below, the skirt 118 functions to retain water within the tank 110.

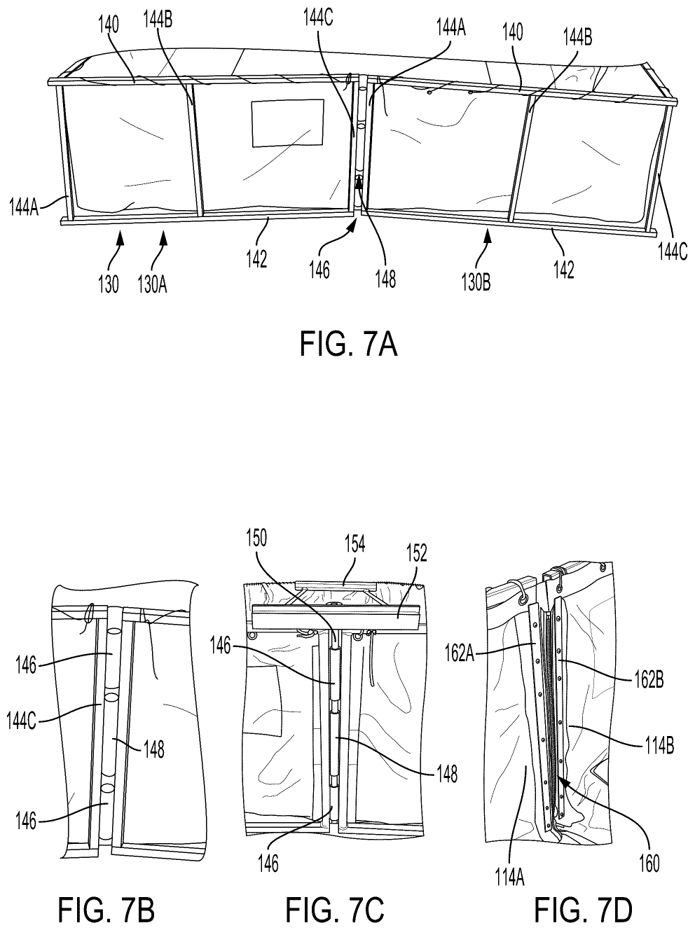

FIGS. 7A-2D depict the first end 130 of the tank 110 and various components thereof, according to one embodiment. As will be discussed in further detail below, the first end 130 of the tank 110 is configured such that the two frame sections 130A, 130B (and the corresponding portion of the receptacle 114 attached thereto) can be detachable from/attachable to each other. As a result, the entire tank 110 can be deployed around a vehicle by unfolding the tank 110 into its deployed position around a target vehicle and attaching the two frame sections 130A, 130B of the first end 130 together. After the tank 110 is filled with water, the fire or thermal runaway in the vehicle is extinguished, and the water is drained, the tank 110 can then be returned to its collapsed configuration by detaching the two sections 130A, 130B of the first end 130 from each other and folding the tank 110 back up into its collapsed configuration (as will also be discussed in additional detail below).

As mentioned above and best shown in FIG. 7A, the first end 130 has two frame sections 130A, 130B, with the first section 130A having an upper rail 140, a lower rail 142, and three vertical posts 144A-C joining the lower rail 142 to the upper rail 140. More specifically, the first frame section 130A has two end posts 144A, 144C and an interior post 144B, with the first end post 144A coupled to the elongate side 134 via rotatable joints (such as hinges) coupled to the upper 140 and lower rails 142 (not shown) and the second end post 144C having a coupling mechanism 146 (as best shown in FIG. 7B) that is configured to couple with the other frame section 130B. In this specific exemplary embodiment, the coupling mechanism 146 is two tubes 146 fixedly attached to the end post 144C such that the two tubes 146 can be aligned with a corresponding tube 148 on the second frame section 130B, thereby allowing a rod or the like to be inserted through the tubes 146, 148 such that the first frame section 130A and second frame section 130B are coupled together. Alternatively, the coupling mechanism 146 (and the corresponding coupling mechanism 148) can be any known device, mechanism, or feature that can be used to couple the first section 130A to the second section 130B.

Like the first frame section 130A, the second frame section 130B has two end posts 144A, 144C and an interior post 144B. In this section 130B, the first end post 144A has a coupling mechanism 148 (as best shown in FIG. 7B) that is configured to couple to the coupling mechanism 146 of the first frame section 140A. Further, the second end post 144C is coupled to the elongate side 136 via rotatable joints (such as hinges) coupled to the upper 140 and lower rails 142 (not shown). In this specific exemplary embodiment as best shown in FIG. 7C, the coupling mechanism 148 is one tube 148 fixedly attached to the end post 144A such that the tube 148 can be aligned with the tubes 146 on the first frame section 130A, thereby allowing a coupling pin or rod 150 to be inserted through the tubes 146, 148 such that the first frame section 130A and second frame section 130B are coupled together. In one implementation, the coupling pin 150 is an elongate rod 150 sized to fit through the tubes 146, 148 as shown, the rod 150 having a coupling bracket 152 disposed near a proximal end of the rod 150 and a handle 154 attached to the bracket 152. The coupling bracket 152 is sized to be positionable over the rails 140 of the sections 130A, 130B such that the bracket 152 is disposed over the rails 140 when the rod 150 is positioned through the tubes 146, 148, thereby helping to restrict the two sections 130A, 130B from moving in relation to each other. Alternatively, the coupling pin 150 can be any known device or mechanism for coupling the two sections 130A, 130B together.

As best shown in FIG. 7D, the flexible receptacle 114 disposed on the inner side of the frame 112 can also have a corresponding coupling mechanism (or mechanisms) 160 disposed adjacent to the coupling mechanisms 146, 148 of the frame 112 as discussed above and elsewhere herein. In the specific implementation as shown, the coupling mechanism 160 is a zipper 160 that allows for attaching and detaching the detachable ends 114A, 114B of the flexible receptacle 114 such that the tank 110 can be deployed and collapsed as discussed above and in further detail below. Alternatively, the coupling mechanism 160 can be any known device, mechanism, or feature that can be used to couple the first end 114A of the receptacle 114 to the second end 114B.

In accordance with certain exemplary embodiments (including the implementation of FIG. 7D), elongate support members 162A, 162B are disposed on each of the ends 114A, 114B of the receptacle 114 adjacent to the zipper 160 to provide structural support to the ends 114A, 114B. More specifically, the first end 114A has an elongate support member 162A attached thereto that is disposed adjacent to and extends along a length of the first end 114A as shown. Similarly, the second end 114B has an elongate support member 162B attached thereto that is disposed adjacent to and extending along a length of the second end 114B as shown. In one embodiment, the elongate support members 162A, 162B have a length substantially similar to, or longer than, the length of the vertical portion of the zipper 160. Alternatively, the members 162A, 162B can have any length. In one embodiment, both elongate support members 162A, 162B are elongate metal plates or strips 162A, 162B that are substantially rigid. Alternatively, the members 162A, 162B can be any substantially rigid structure or material that can be attached to the ends 114A, 114B to provide structural support thereto.

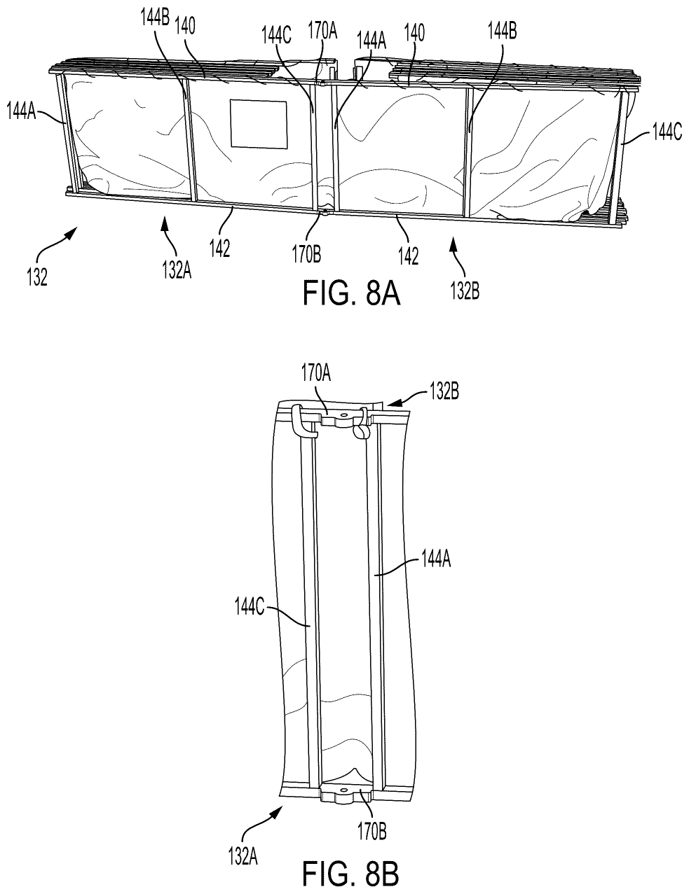

FIGS. 8A-8B depict the second end 132 of the tank 110 and various components thereof, according to one embodiment. As mentioned above and best shown in FIG. 8A, the second end 132 has two frame sections 132A, 132B, with the first section 132A having an upper rail 140, a lower rail 142, and three vertical posts 144A-C joining the lower rail 142 to the upper rail 140. More specifically, the first frame section 132A has two end posts 144A, 144C and an interior post 144B, with the first end post 144A (and rails 140, 142) coupled to the elongate side 136 via rotatable joints (such as hinges) coupled to the upper 140 and lower rails 142 (not shown) and the second end post 144C (and rails 140, 142) coupled to the second section 132B via rotatable joints 170A, 170B coupled to the upper 140 and lower rails 142 (as best shown in FIG. 8B). Further, the second frame section 132B also has two end posts 144A, 144C and an interior post 144B. In this section 132B, the first end post 144A (and rails 140, 142) are coupled to the first section 132A via the rotatable joints 170A, 170B discussed above, and the second end post 144C (and rails 140, 142) are coupled to the elongate side 134 via rotatable joints (such as hinges) coupled to the upper 140 and lower rails 142 (not shown).

In the exemplary embodiment as shown, the joints 170A, 170B are known hinges 170A, 170B disposed on the outer side of the rails 140, 142 such that the two sections 132A-B (and more specifically, the first end post 144A of section 132A and the second end post 144C of section 132B) fold outwardly (away from the interior of the tank 110) around the axis at the joints 170A, 170B. In contrast, the joints (such as hinges, not shown) coupling the first section 132A to the side 136 and the joints (such as hinges, not shown) coupling the second section 132B to the side 134 are disposed on the inner side of the rails 140, 142 such that the rotatably coupled sections can fold inwardly (toward the interior of the tank 110).

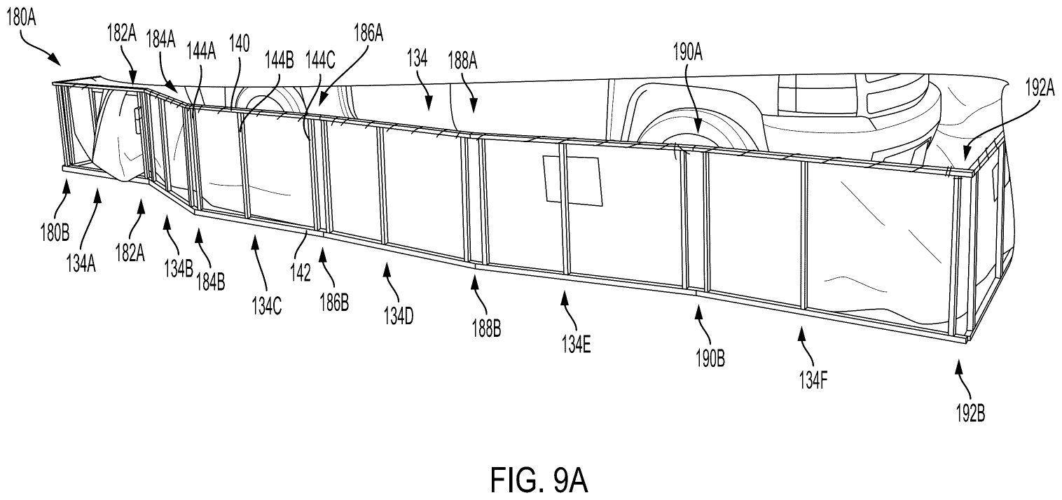

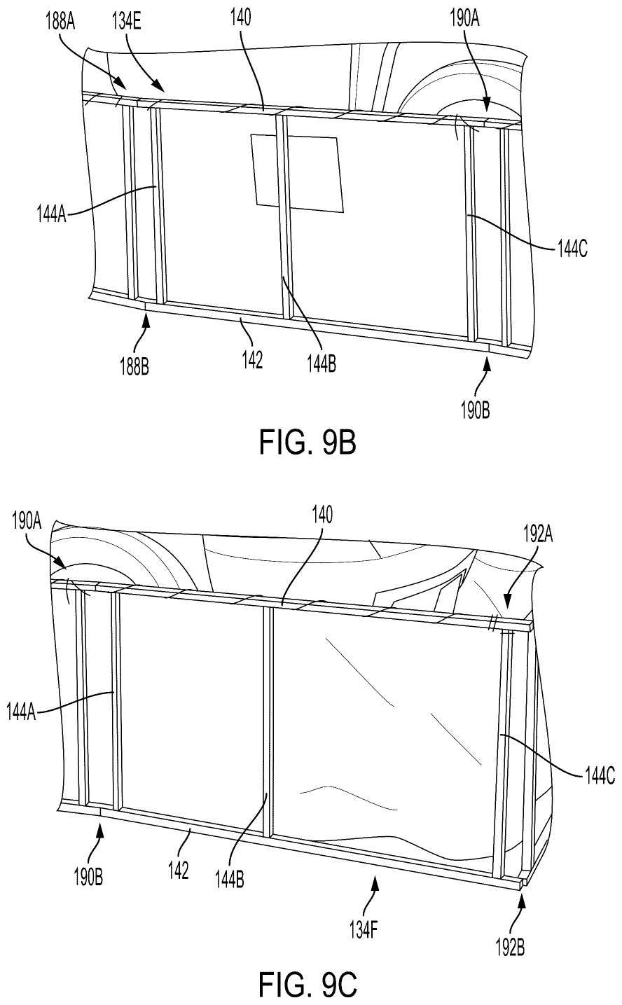

FIGS. 9A-9C depict the first elongate side 134 of the tank 110 and various components thereof, according to one embodiment. While the figures and the discussion below are directed to the first elongate side 134, it is noted that the second elongate side 136 has substantially the same components and functions in substantially the same way. As mentioned above and best shown in FIG. 9A, the first side 134 has six frame sections 134A-134F, with each such section 132A-F (such as representative section 134E in FIG. 9B) having an upper rail 140, a lower rail 142, and three vertical posts 144A-C joining the lower rail 142 to the upper rail 140. In addition, each section 134A-134F has joints at each end of the section, with the joints at one end configured to fold inward and the joints at the other end configured to fold outward. More specifically, as best shown in FIG. 9A, section 134A has joints 180A, 180B at one end that fold inward (and are coupled to the section 132B of the second end 132) and joints 182A, 182B at the other end that fold outward, section 134B is coupled at one end to section 134A at the joints 182A-B (that fold outward) and is coupled to section 134C via joints 184A, 184B at the other end that fold inward, section 134C is coupled at one end to section 134B at the joints 184A-B (that fold inward) and is coupled to section 134D via joints 186A, 186B at the other end that fold outward, section 134D is coupled at one end to section 134C at the joints 186A-B (that fold outward) and is coupled to section 134E via joints 188A, 188B at the other end that fold inward, section 134E (as shown in further detail in FIG. 9B) is coupled at one end to section 134D at the joints 188A-B (that fold inward) and is coupled to section 134F via joints 190A, 190B at the other end that fold outward, and section 134F (as shown in further detail in FIG. 9C) is coupled at one end to section 134E at the joints 190A-B (that fold outward) and is coupled at the other end to the first section 130A of the first end 130 via joints 192A, 192B that fold inward.

Thus, in the exemplary implementation as discussed above, the two elongate sides 134, 136 are made up of multiple frame sections (such as sections 134A-F in first elongate side 134), wherein each of the frame sections has joints on each end that allow for folding in opposite directions, as discussed above. As will be described in detail below, this configuration allows for the quick and easy deployment of the frame 112 from a transportable collapsed configuration into a fully deployed tank disposed around a target vehicle and subsequently back to the collapsed configuration.

In certain embodiments, the joints 180A-192B discussed above with respect to the first elongate side 134 (along with the second elongate side 136 and any or all of the other joints anywhere in the frame 112 as disclosed or contemplated herein) are hinges. More specifically, any and all of the various joints herein can be standard hinges for collapsible tank frames, such as the hinges disclosed in U.S. Pat. Nos. 7,905,368 and 7,938,291, both of which are hereby incorporated herein by reference in their entireties. In those embodiments in which the joints are hinges, the hinges that allow for folding sections inwardly can be hinges disposed on the inner side of the sections, while the hinges that allow for folding sections outwardly can be hinges disposed on the outer side of the sections. Alternatively, any of the joints in the frame 112 can be any known mechanisms or components of any configuration that allow for attachment of the various frame sections and rotation or folding of those sections in the desired direction in relation to each other.

In use, the tank 110 can be deployed and collapsed in the following fashion, according to one embodiment. For ease of understanding, the collapse of the tank 110 will be depicted and discussed first, followed by the deployment.

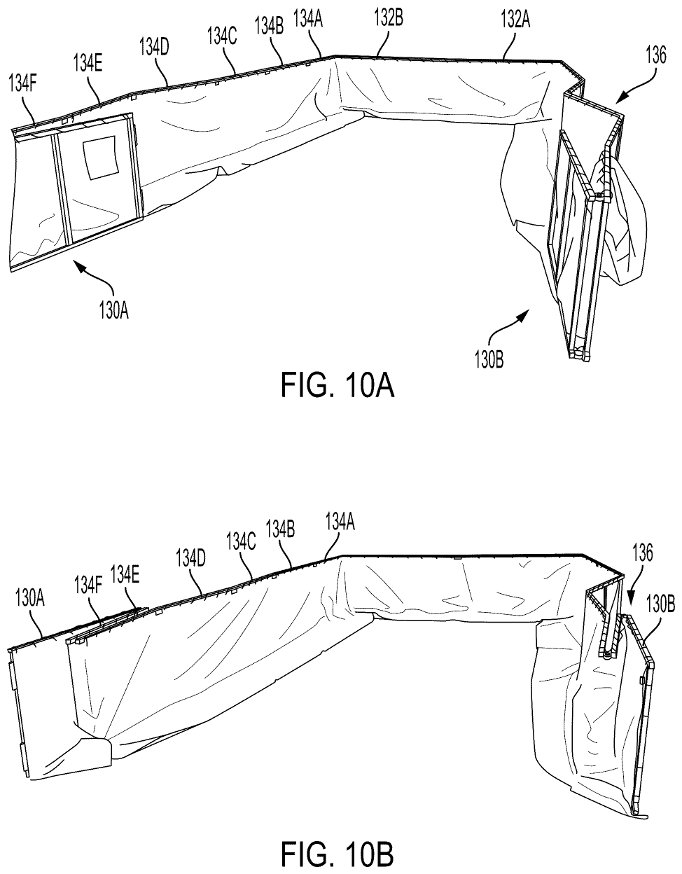

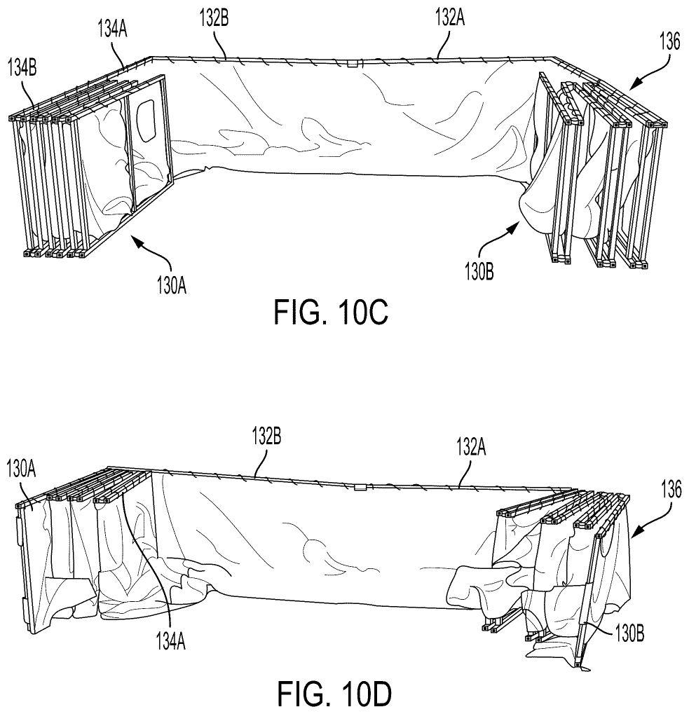

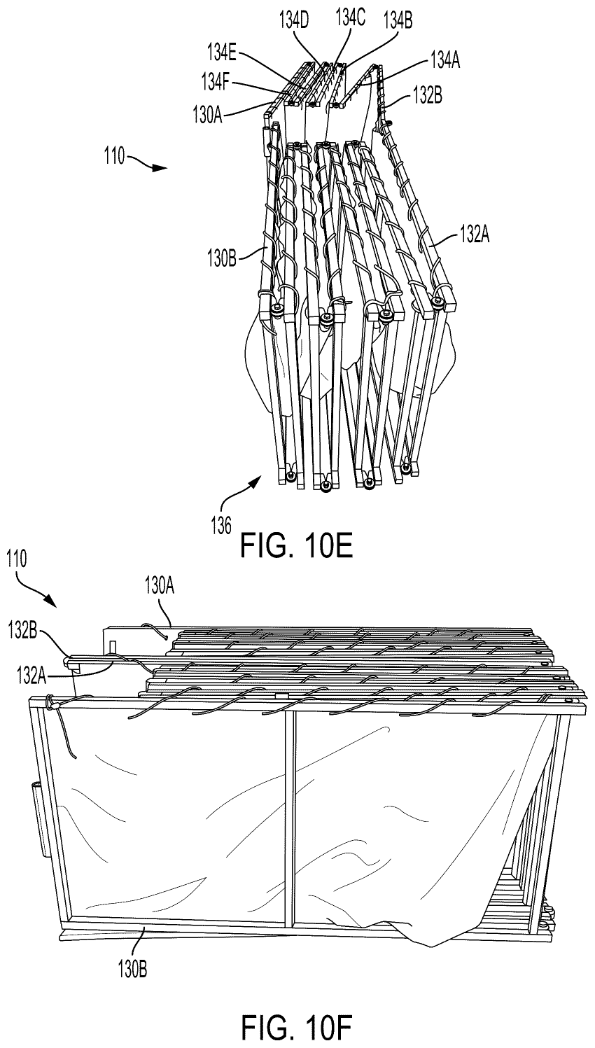

FIGS. 10A-10F depict the collapse of the tank 110, according to one embodiment. As shown in FIG. 10A, the two frame sections 130A, 130B are first detached from each other and rotated or folded inward such that they are parallel with the sections of the elongate sides 134, 136 to which they are coupled. For example, section 130A is rotated inward until it is parallel with and adjacent to the frame section 134F as shown. Next, as shown in FIG. 10B, both sections 130A, 134F (and the equivalent sections 130B and the attached section of the side 136) are rotated outward until both are disposed on the exterior side of, parallel with, and adjacent to the section 130E (and the corresponding section of the side 136). This alternating rotation (inward, outward, inward, etc.) continues such that the sides 134, 136 are collapsed in an accordion-like fashion until, as shown in FIG. 10C, the section 130A and adjacent sections 134C-134F are disposed on the interior side of and adjacent to section 134B (and the corresponding sections on the side 136 are similarly positioned). Then as shown in FIG. 10D, all of those folded sections are rotated outward such that the section 130A and adjacent sections 134B-134F are disposed on the exterior side of and adjacent to section 134A (and the corresponding sections on the side 136 are similarly positioned). Next, as shown in FIG. 10E, all of the folded sections are rotated inward such that the section 130A and adjacent sections 134A-134F are disposed on the interior side of an adjacent to section 132B (and the corresponding sections on the side 136 are similarly positioned). Finally, as shown in FIG. 10F, all of the folded sections of both sides 134, 136 are once again rotated outward such that sections 132A, 132B are positioned adjacent to each other with all of the other sections disposed parallel to the sections 132A, 132B in the fully collapsed configuration.

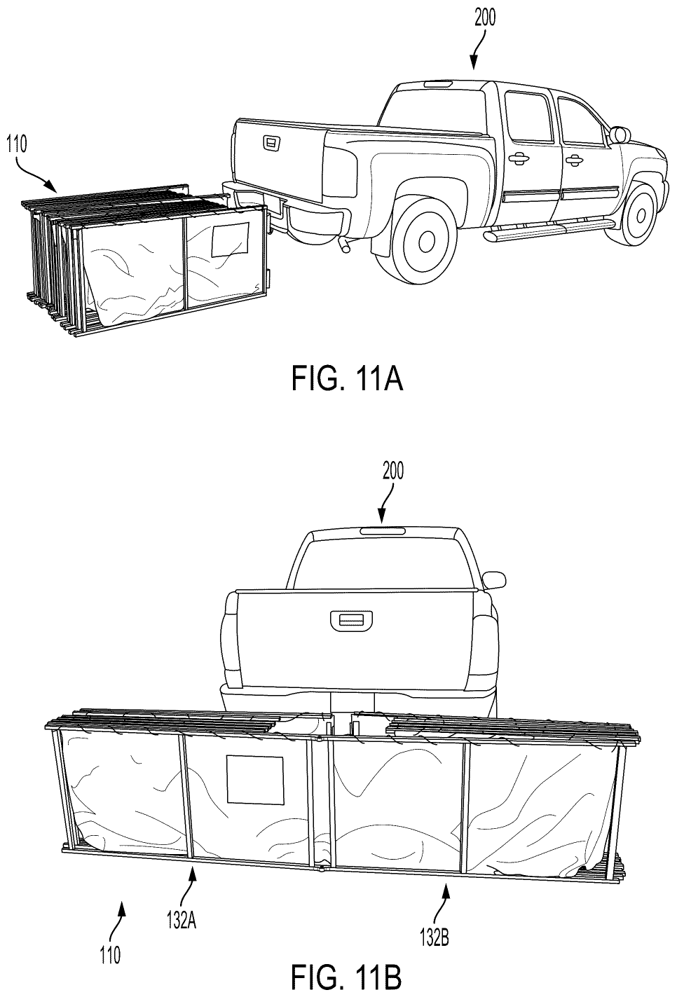

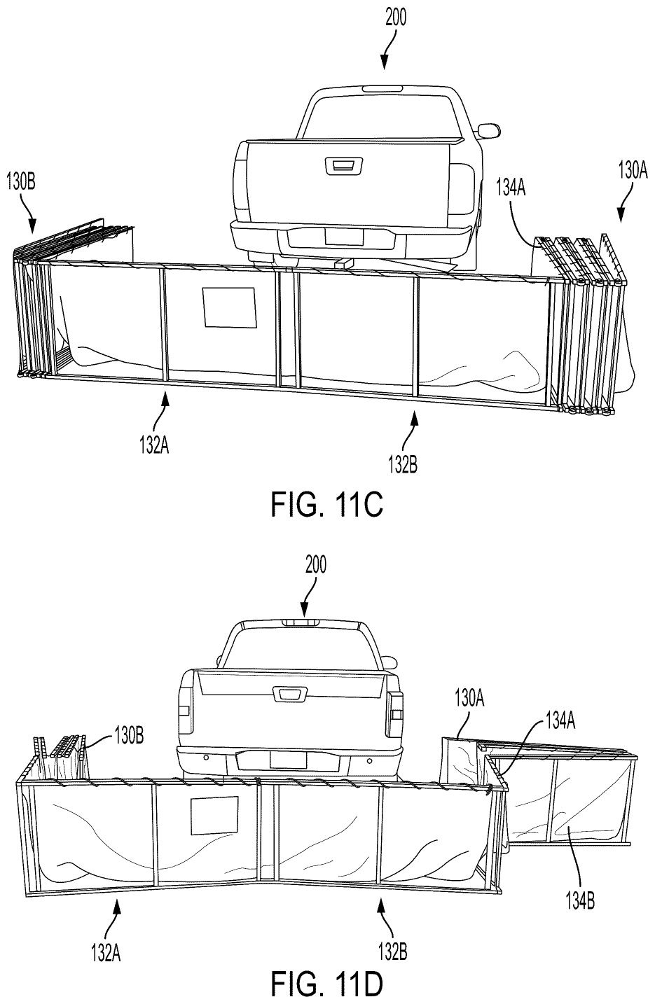

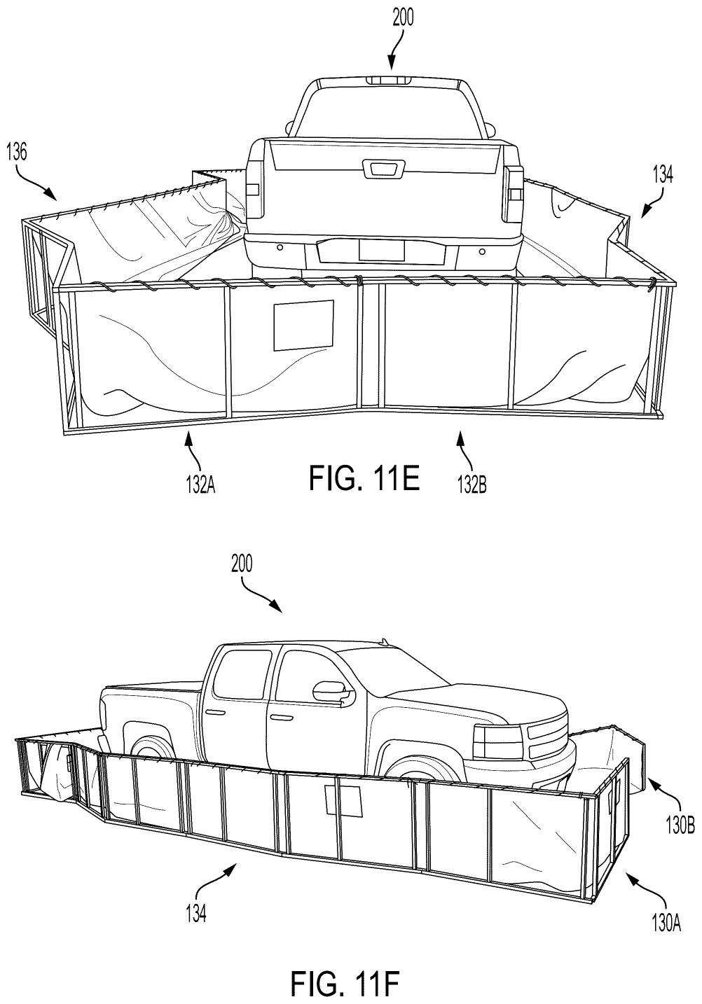

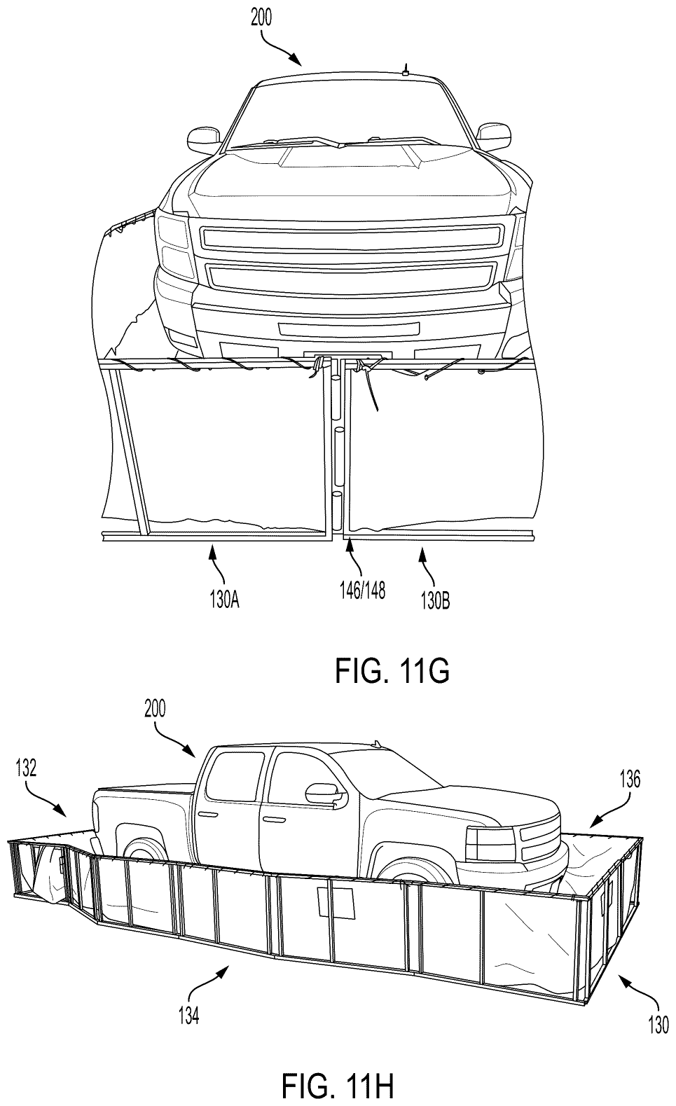

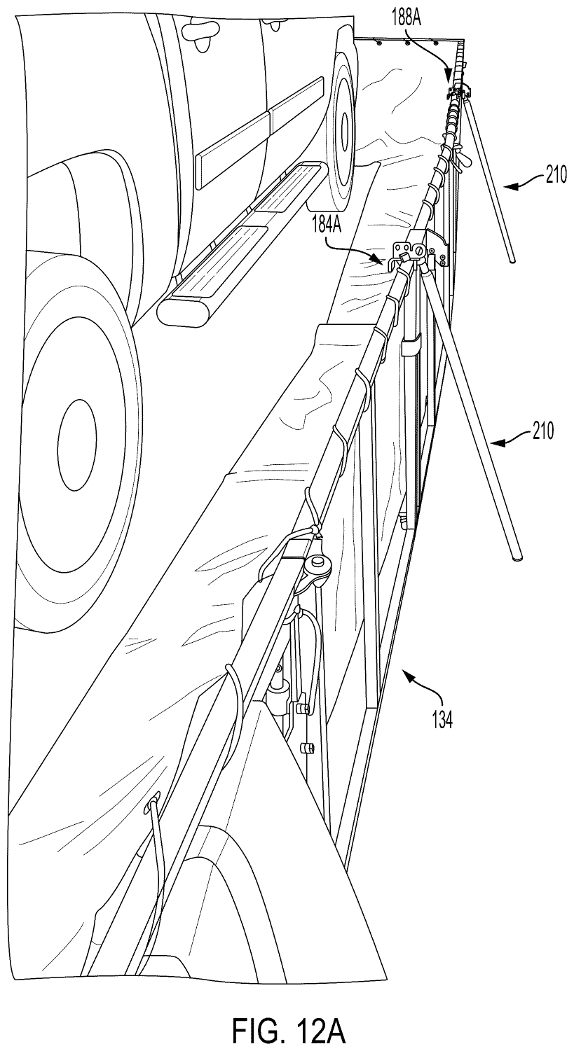

In accordance with one implementation, the tank 110 can be deployed in a similar (reverse) fashion, as depicted in FIGS. 11A-11H. First, the tank 110 in its collapsed position is positioned on one end of the target vehicle 200, as shown in FIG. 11A. In the exemplary embodiment as shown, the collapsed tank 110 is positioned behind the back end of the vehicle 200 prior to deployment, but it could just as easily be positioned in front of the front end of the vehicle 200. As shown in FIG. 11B, once the tank 110 is positioned in relation to the vehicle 200 as desired, the two second end sections 132A, 132B are rotated away from each other (along with all of the sections disposed adjacent to and parallel with those sections 132A, 132B) as shown. At this point, the two end sections 132A, 132B are deployed That is, the two end sections 132A, 132B are disposed as they will be positioned when the entire tank 110 is fully deployed (as can be seen in FIG. 11E). Next, as shown in FIG. 11E, the section 134A (along with section 130A and all the other sections 134B-F of the side 134) is rotated away from section 132B, and similarly, the corresponding sections of side 136 along with section 130B are rotated away from section 132A such that both section 134A and the corresponding section of side 136 are disposed in their final deployed position. Subsequently, as shown in FIG. 11D, section 134B (along with section 130A and all sections disposed therebetween) is rotated away from section 134A until section 134B is ultimately disposed in its final (or near final) deployed position (as best shown in FIG. 11H) and similarly, the corresponding sections of side 136 along with section 130B are also rotated in a similar fashion as shown. This deployment or unfolding of both sides 134, 136 continues in a similar fashion until the sides 134, 136 extend along the length of the vehicle and the end sections 130A, 130B are capable of being positioned to enclose the vehicle 200 as shown in FIGS. 11E and 11F. At this point, as shown in FIGS. 11G and 11H, the two sections 130A, 130B are coupled together at the coupling mechanisms 146, 148, thereby resulting in the full deployment of the tank 110 such that the tank 110 is ready to be filled with water. In one embodiment, the zipper 160 of the flexible receptacle 114 is also zipped up to attach the two ends of the receptacle 114A, 114B together.

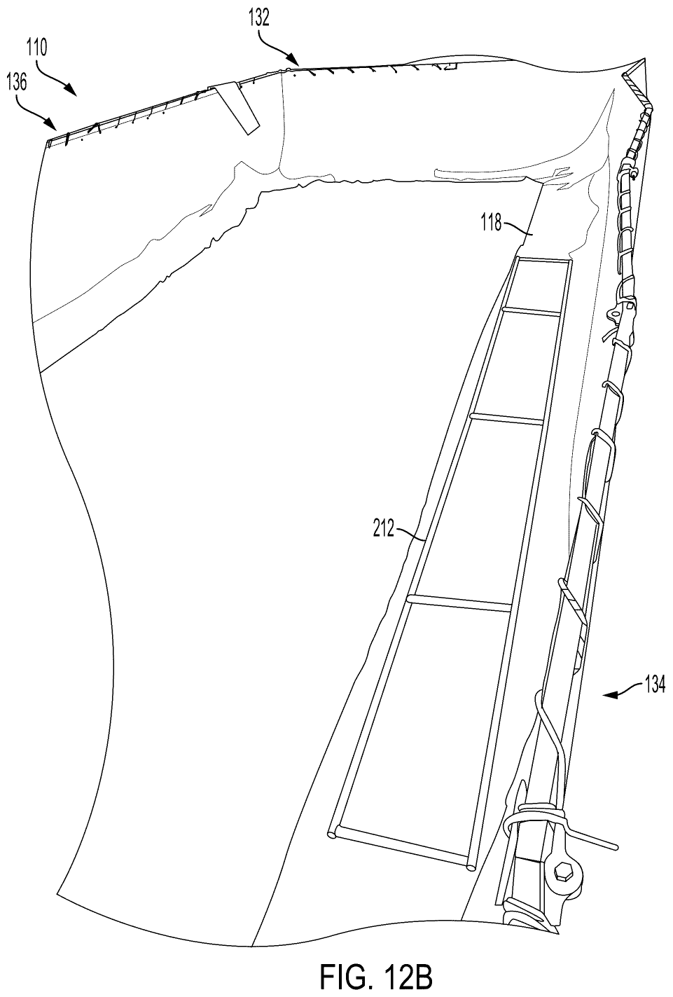

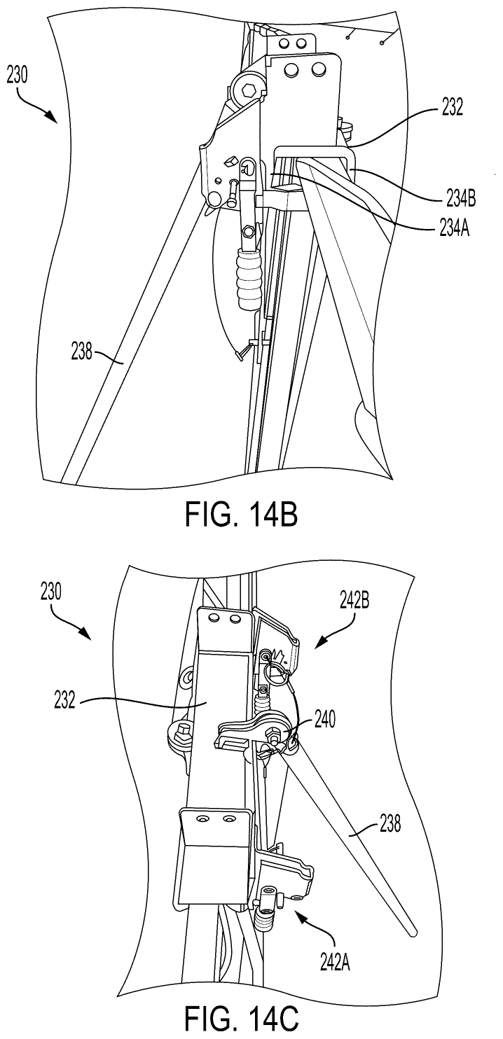

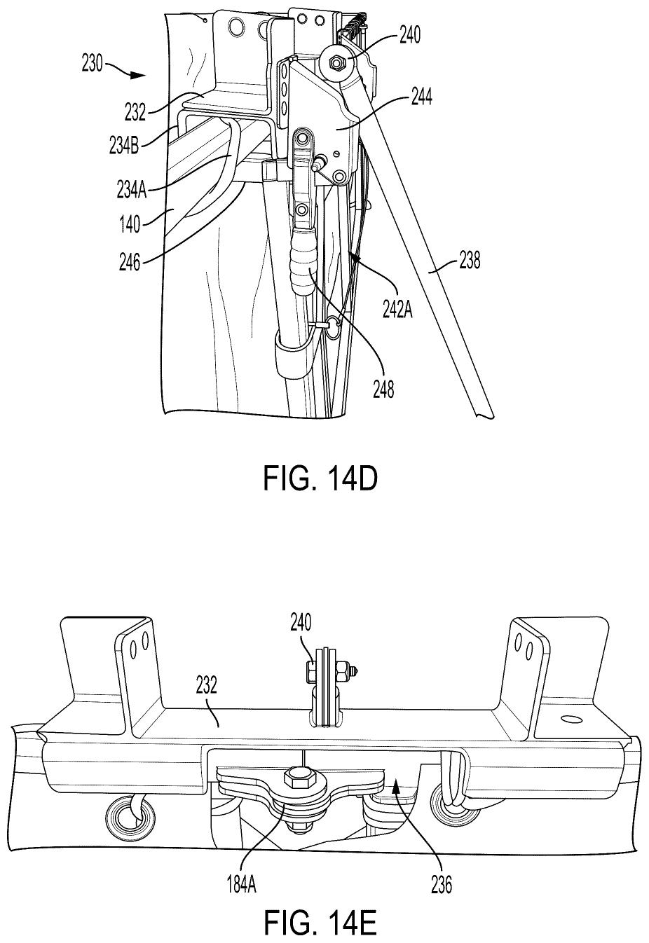

In accordance with certain implementations as shown in FIG. 12A, once the tank 110 is fully deployed, a predetermined number of external support structures (also referred to herein as “legs” or “outriggers”) 210 can be attached to the top rails 140 along the sides 134, 136 (with only side 134 visible in the figure). In one embodiment, there is a support structure 210 attached to each side 134, 136 at each of the joints that allow for rotation of the adjacent sections inward (such that each such joint is susceptible to bowing outward when interior pressure created by the water therein is applied to create an outward directed force along the sides 134, 136). Thus, in one example with reference to FIGS. 9A and 12A, an external support structure 210 would be attached to the top joints 184A and 188A alongside 134 as shown. One specific embodiment of an external support structure 230 that can be used with any tank 110 embodiment herein will be discussed in further detail below with respect to FIGS. 14A-14E. Alternatively, any external support structure can be used that can prevent the joints from bowing outward and/or completely collapsing when the tank 110 has water contained therein.

As shown in FIG. 12B, in certain optional embodiments, a skirt anchor (or “weight”) 212 is provided for use with the tank 110. More specifically, after deployment of the tank 110 (as shown in FIG. 11H, for example), the skirt anchor 212 can be disposed on any portion of the skirt 118 to hold the skirt 118 down/against the surface that the tank 110 is positioned on to ensure that the water being added to the tank 110 substantially remains therein and doesn't begin flowing out of the tank 110 underneath the skirt 118. According to one embodiment, the skirt anchor 212 as shown has a length that allows it to be positioned on either of the skirts 118 disposed along the length of one of the elongate sides 134, 136. Alternatively, the skirt anchor 212 (or a second such anchor) can have a length that allows it to be positioned on either of the skirts 118 disposed along the length of the ends 130, 132. In a further implementation, four skirt anchors 212 of appropriate lengths are provided.

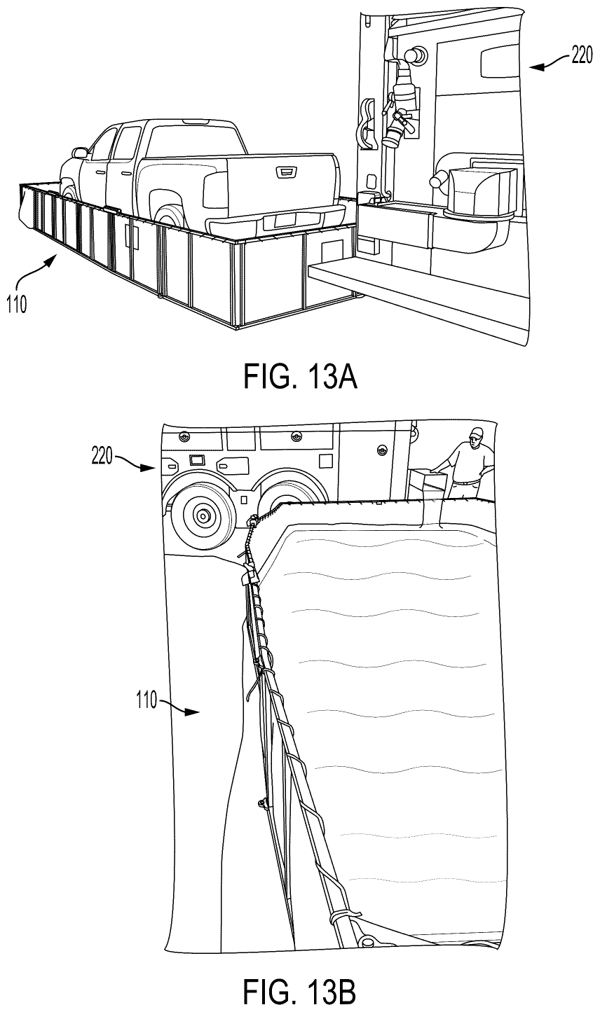

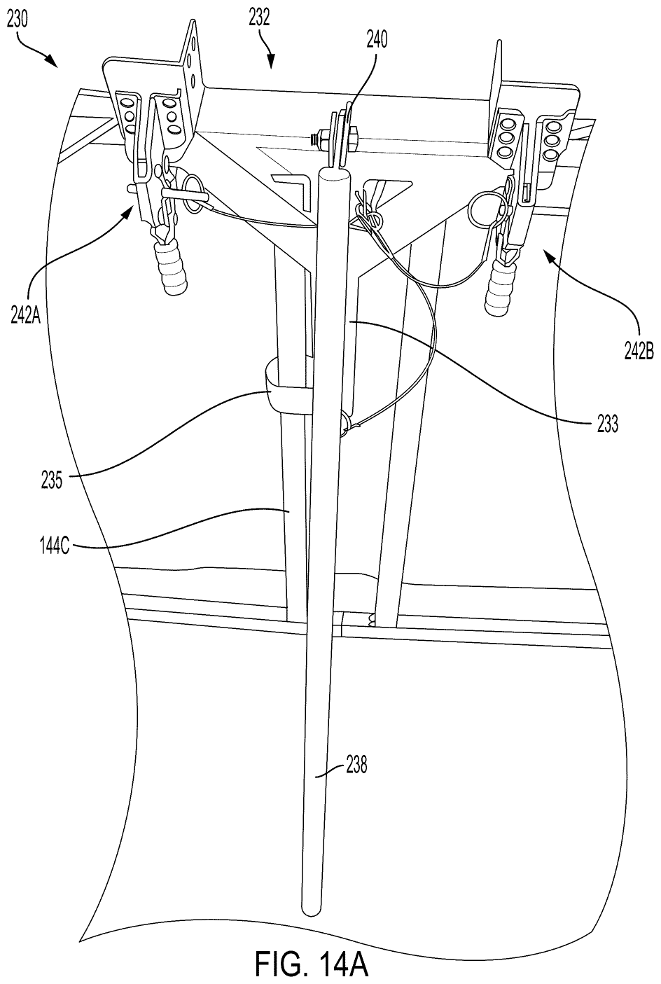

In use, once the tank 110 is deployed (and, in certain embodiments, the external support structures (such as structure 210) are attached thereto), the tank 110 can be filled with water. In certain embodiments, a firetruck 220 is positioned next to the tank 110 and the tank 110 is filled as shown in FIGS. 13A and 13B. Alternatively, a hose could be connected to a nearby fire hydrant and used to fill the tank 110. In a further alternative, any water source and/or appropriate transport device can be used to fill the tank 110.

According to certain embodiments, when the deployed tank 110 begins to be filled with water, turbulence and/or the force of the water being introduced into the tank 110 can cause any portion of the skirt 118 to lift away from the surface on which the tank 110 is positioned, thereby allowing the water to flow out of the tank 110 underneath the skirt 118. When this happens, one or more skirt anchors 212 as discussed above can be positioned over that portion of the skirt 118, thereby maintaining the position of skirt 118 against the surface and minimizing the amount water flowing out. Once a sufficient amount of water has been added to the tank 110, the weight of the water on the skirt 118 provides sufficient force to prevent any portion of the skirt 118 from lifting away from the surface, and the anchor 212 can be removed.

During use, it should be noted that some minimal amount of water may escape from the tank 110 via the zipper 160 and underneath the skirt 118. However, surprisingly, the amount of water that escapes is a minimal amount such that the tank 110 retains a sufficient amount of water for a sufficient amount of time to ensure that the fire or thermal runaway in the vehicle disposed within the tank is extinguished. Testing has shown that the skirt 118 makes it possible to retain sufficient amounts of water across a wide variety of surfaces, including smooth pavement, gravel, and other such surfaces.

One exemplary embodiment of an external support structure 230 is depicted in FIGS. 14A-14E. The structure 230 has a top rail attachment body 232 that is disposed over the top rail of the frame (such as top rail 140 of the frame 112 as discussed above) such that the sides 234A, 234B are disposed on either side of the rail as best shown in FIG. 14B and 14D. Further, the internal side 234B can have a gap or opening 236 defined therein such that the hinge on the top rail (such as a hinge 184A on top rail 140) can be positioned within the opening as shown. In addition, as best shown in FIGS. 14A and 14D, the body 232 has a support arm 233 attached thereto that extends downward from the body 232 and has an engagement structure 235 that can be engaged with the end post 144C of one of the two sections to which the external support structure 230 is attached. In one embodiment, the engagement structure 235 is a C-shaped structure 235 that is shaped to fit around the end post 144C as shown. Alternatively, the engagement structure 235 can be any known mechanism or structure that can be used to removably attach the support arm 233 to the end post 144C. In one embodiment, the support arm 233 and engagement structure 235 provides additional attachment of the external support structure 230 to the frame 112.

Rotatably attached to the body 232 is a leg 238 (as best shown in FIGS. 14A and 14C) that extends downward from the body 232 to be positioned on the ground/floor/surface adjacent to and on the external side of the frame (such as frame 112). More specifically, in this specific exemplary embodiment as best shown in FIGS. 14A and 14C, the body 232 has a joint housing 240 that extends from the body 232 and allows for rotatable coupling of the top end of the leg 238 thereto. Alternatively, the leg 238 can be rotatably coupled to the housing via any known mechanism or component.

Further, according to certain embodiments, the attachment body 232 can also have two attachment clamps 242A, 242B that assist with attachment to the top rail (such as rail 140). In this particular example as best shown in FIG. 14D, each clamp 242A, 242B has a clamp body 244 attached to the attachment body 232, with a rotatable clamping arm 246 rotatably attached to the clamp body 244 that moves between an open position and a closed or clamped position (with the clamped position depicted in FIG. 14D). The actuatable handle 248 is operably coupled to the rotatable clamping arm 246 such that the handle 248 can be used to urge the clamping arm 246 between its open position and its closed position. In use, once the attachment body 232 is disposed over the target joint as desired and the leg 238 is positioned against the ground/floor/surface as desired, the actuatable handle 248 can be used to urge the arm 246 into its closed position under the rail (such as rail 140), thereby clamping or otherwise retaining the attachment body 232 and the entire structure 230 in place on the rail. While the various components of the clamp 242A is discussed in relation to the first clamp 242A as depicted in FIG. 14D, it is understood that the second clamp 242B has substantially the same components and functions in substantially the same way.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount—including any integer—between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2,3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

Although the various embodiments have been described with reference to preferred implementations, persons skilled in the art will recognize that changes may be made in form and detail without departing from the spirit and scope thereof.

What is claimed is:

1. A portable, deployable water tank, comprising:
(a) a folding frame comprising:
(i) a first frame half comprising:
(A) a first end comprising first and second end sections, wherein the first end section is rotatably coupled to the second end section;
(B) a first side rotatably coupled at a first end of the first side to the first end, the first side comprising a plurality of first side sections, wherein each of the first side sections is rotatably coupled to at least one adjacent first side section such that the first side is foldable with the first end in an accordion-like fashion; and
(C) a second side rotatably coupled at a first end of the second side to the first end, the second side comprising a plurality of second side sections, wherein each of the second side sections is rotatably coupled to at least one adjacent second side section such that the second side is foldable with the first end and the first side in an accordion-like fashion;
(ii) a second frame half selectively couplable and decouplable from the first frame half, the second frame half comprising:
(A) a second end comprising first and second end sections, wherein the first end section is rotatably coupled to the second end section;
(B) a first side rotatably coupled at a first end of the first side to the second end, the first side comprising a plurality of first side sections, wherein each of the first side sections is rotatably coupled to at least one adjacent first side section such that the first side is foldable with the second end in an accordion-like fashion; and
(C) a second side rotatably coupled at a first end of the second side to the second end, the second side comprising a plurality of second side sections, wherein each of the second side sections is rotatably coupled to at least one adjacent second side section such that the second side is foldable with the second end and the first side in an accordion-like fashion; and
(iii) a coupling mechanism disposed at a second end of each of the first and second sides of each of the first and second frame halves and configured to couple and decouple the first frame half and the second frame half;
wherein each of the first frame half and the second frame half are moveable between a collapsed configuration and a deployed configuration; and
(b) a flexible receptacle attached to the folding frame, the flexible receptacle comprising vertical sidewalls and a skirt extending inwardly from a bottom portion of the vertical sidewalls, wherein the skirt is disposed substantially flat on a surface when the folding frame is in the deployed configuration.

2. The portable, deployable water tank of claim 1, further comprising a coupler configured to operably engage the coupling mechanism between first and second sides of the first and second frame halves.

3. The portable, deployable water tank of claim 1, further comprising first and second couplers, wherein:
(i) the first coupler is configured to engage and couple the second end of the first side of the first frame half with the second end of the first side of the second frame half; and
(ii) the second coupler is configured to engage the second end of the second side of the first frame half with the second end of the second side of the second frame half.

4. The portable, deployable water tank of claim 1, further comprising at least a first and a second external support structure, wherein each of the first and second external support structures comprise:
(a) a top rail attachment body coupleable to a top rail of the folding frame;
(b) a leg rotatably coupled to the top rail attachment body, wherein the leg is rotatable into a position external to the frame such that the leg is in contact with the surface, whereby the leg is configured to provide structural support to the frame,
wherein the first external support structure is coupleable to the first side and the second external support structure is coupleable to the second side.

5. The portable deployable water tank of claim 1, wherein the flexible receptacle comprises a first end and a second end, wherein the first and second ends are coupleable to each other via a receptacle attachment structure, wherein the receptacle attachment structure is disposed substantially adjacent to the frame coupling structure.

6. The portable deployable water tank of claim 1, wherein the flexible receptacle comprises a first receptacle half and a second receptacle half each associated with the first frame half and the second frame half, respectively.

7. The portable deployable water tank of claim 6, wherein each of the first and second receptacle halves comprise first and second ends, and wherein the first ends of the first and second receptacle halves are configured to couple with one another at a first connection, and the second ends of the first and second receptacle halves are configured to couple with one another at a second connection.

8. The portable deployable water tank of claim 7, wherein each of the first and second receptacle halves comprises a main receptacle layer and wherein each of the first and second connections comprise:
(i) a main junction between the main receptacle layers of the first and second receptacle halves;
(ii) a secondary junction comprising a strip operably removably coupled to the main receptacle layers of each of the first and second receptacle halves and covering the main junction; and
(iii) a tertiary overlay having a fixed joint with one of the first and second receptacle halves and a selectively removable joint with the other of the first and second receptacle halves;
wherein the tertiary overlay covers both the main junction and the secondary junction.

9. The portable deployable water tank of claim 8, wherein the secondary junction comprises a strip that is operably and removably coupled to one or both of the first and second receptacle halves.

10. The portable deployable water tank of claim 8, wherein the selectively removable joint comprises a hook and loop connection.

11. The portable deployable water tank of claim 1, further comprising at least one floor weight placed on a top side of the skirt.

12. A portable, deployable water tank, comprising:
(a) a folding frame defining a tank perimeter, the folding frame comprising:
(i) a first frame half comprising:
(A) a first end comprising first and second end sections, wherein the first end section is rotatably coupled to the second end section;
(B) a first side rotatably coupled at a first end of the first side to the first end, the first side comprising a plurality of first side sections, wherein each of the first side sections is rotatably coupled to at least one adjacent first side section such that the first side is foldable with the first end in an accordion-like fashion; and
(C) a second side rotatably coupled at a first end of the second side to the first end, the second side comprising a plurality of second side sections, wherein each of the second side sections is rotatably coupled to at least one adjacent second side section such that the second side is foldable with the first end and the first side in an accordion-like fashion;
(ii) a second frame half selectively couplable and decouplable from the first frame half, the second frame half comprising:
(A) a second end comprising first and second end sections, wherein the first end section is rotatably coupled to the second end section;
(B) a first side rotatably coupled at a first end of the first side to the second end, the first side comprising a plurality of first side sections, wherein each of the first side sections is rotatably coupled to at least one adjacent first side section such that the first side is foldable with the second end in an accordion-like fashion; and
(C) a second side rotatably coupled at a first end of the second side to the second end, the second side comprising a plurality of second side sections, wherein each of the second side sections is rotatably coupled to at least one adjacent second side section such that the second side is foldable with the second end and the first side in an accordion-like fashion; and
(iii) a coupling mechanism disposed at a second end of each of the first and second sides of each of the first and second frame halves and configured to couple and decouple the first frame half and the second frame half;
wherein each of the first frame half and the second frame half are moveable between a collapsed configuration and a deployed configuration; and
(b) a flexible receptacle attached to the folding frame, the flexible receptacle comprising
(i) vertical sidewalls disposed on an inner side of the frame around the tank perimeter, the vertical sidewalls comprising a first end and a second end;
(ii) a skirt extending inwardly from a bottom portion of the vertical sidewalls, wherein the skirt is disposed substantially flat on a surface when the folding frame is in the deployed configuration;
(iii) a receptable attachment structure disposed at the first end and the second such that the first and second ends are attachable to each other at the receptacle attachment structure, wherein the receptacle attachment structure is disposed substantially adjacent to the frame coupling structure.

13. The portable deployable water tank of claim 12, wherein the flexible receptacle comprises a first receptacle half and a second receptacle half each associated with the first frame half and the second frame half, respectively.

14. The portable deployable water tank of claim 13, wherein each of the first and second receptacle halves comprise first and second ends, and wherein the first ends of the first and second receptacle halves are configured to couple with one another at a first connection, and the second ends of the first and second receptacle halves are configured to couple with one another at a second connection.

15. The portable deployable water tank of claim 14, wherein each of the first and second receptacle halves comprises a main receptacle layer and wherein each of the first and second connections comprise:
(i) a main junction between the main receptacle layers of the first and second receptacle halves;
(ii) a secondary junction comprising a strip operably removably coupled to the main receptacle layers of each of the first and second receptacle halves and covering the main junction; and
(iii) a tertiary overlay having a fixed joint with one of the first and second receptacle halves and a selectively removable joint with the other of the first and second receptacle halves;
wherein the tertiary overlay covers both the main junction and the secondary junction.

16. The portable deployable water tank of claim 15, wherein the secondary junction comprises a strip that is operably and removably coupled to one or both of the first and second receptacle halves.

17. The portable deployable water tank of claim 15, wherein the selectively removable joint comprises a hook and loop connection.

18. A portable, deployable water tank, comprising:
(a) a folding frame comprising:
(i) a frame half comprising:
(A) a first end comprising first and second end sections, wherein the first end section is rotatably coupled to the second end section;
(B) a first side rotatably coupled at a first end of the first side to the first end, the first side comprising a plurality of first side sections, wherein each of the first side sections is rotatably coupled to at least one adjacent first side section such that the first side is foldable with the first end in an accordion-like fashion; and
(C) a second side rotatably coupled at a first end of the second side to the first end, the second side comprising a plurality of second side sections, wherein each of the second side sections is rotatably coupled to at least one adjacent second side section such that the second side is foldable with the first end and the first side in an accordion-like fashion;
(ii) a coupling mechanism disposed at a second end of each of the first and second sides of the frame half;
wherein the frame half is moveable between a collapsed configuration and a deployed configuration; and
wherein the frame half is connectable to one or more additional frame halves via the coupling mechanism to define the folding frame; and
(b) a flexible receptacle attached to the folding frame, the flexible receptacle comprising
(i) vertical sidewalls disposed on an inner side of the frame, the vertical sidewalls comprising a first end and a second end;
(ii) a skirt extending inwardly from a bottom portion of the vertical sidewalls, wherein the skirt is disposed substantially flat on a surface when the folding frame is in the deployed configuration;
(iii) a receptable attachment structure disposed at the first end and the second such that the first and second ends are attachable to each other at the receptacle attachment structure, wherein the receptacle attachment structure is disposed substantially adjacent to the frame coupling structure.

19. The portable, deployable water tank of claim 18, further comprising a coupler configured to operably engage the coupling mechanism between first and second sides of each of the frame half and the one or more additional frame halves.

20. The portable, deployable water tank of claim 18, further comprising first and second couplers, wherein:
(a) the first coupler is configured to engage and couple the second end of the first side of the frame half with the second end of the first side of one of the one or more additional frame halves; and
(b) the second coupler is configured to engage the second end of the second side of the first frame half with the second end of the second side of the second frame half.
